(19) United States
(12) Patent Application Publication
(10) Pub. No.: US 2024/0354320 A1
(43) Pub. Date: Oct. 24, 2024

(54) SYSTEM AND METHOD FOR DIVERSE THOUGHT OBJECT SELECTION USING LLM AND EMBEDDING MODELS

(71) Applicant: Fulcrum Management Solutions Ltd., Rossland (CA)

(72) Inventors: Thomas John Procter, Rossland (CA); Farhad Imani, Rossland (CA)

(21) Appl. No.: 18/759,887

(22) Filed: Jun. 30, 2024

Related U.S. Application Data
(63) Continuation-in-part of application No. 17/206,110, filed on Mar. 18, 2021, now Pat. No. 12,038,956.
Application No. 17/206,110 is a continuation of application No. 16/726,826, filed on Dec. 25, 2019, now Pat. No. 10,956,465.
Application No. 16/726,826 is a continuation of application No. 15/066,303, filed on Mar. 10, 2016, now Pat. No. 10,891,639.
(60) Provisional application No. 61/951,044, filed on Mar. 11, 2014.
(60) Provisional application No. 61/880,578, filed on Sep. 20, 2013.

(51) Int. Cl. G06F 16/33; G06F 16/335; G06F 16/338; G06F 40/103; G06F 40/177; G06F 40/284

(52) U.S. Cl. CPC G06F 16/3334; G06F 16/3344; G06F 16/335; G06F 16/338; G06F 40/103; G06F 40/177; G06F 40/284

(57) ABSTRACT

A thought object selection server receives a plurality of thought objects and the thought objects include text present in qualitative responses from plurality of user devices in a communication environments. The plurality of thought objects consists of M thought objects that are most recently seen thought objects and N thought objects that are least seen by the plurality of user devices. A prompt is provided to the LLM with the M thought objects, the N thought objects, and a request to identify diverse thought objects. LLM compares the M thought objects and the N thought objects to identify dissimilar one or more dissimilar thought objects from the N thought objects based on semantic distances. One thought object is selected from the dissimilar thought objects as a diverse thought object. In some cases, non-transformer based embedding tools may be used to identify diverse thought in the received thought objects.

### CROSS-REFERENCE TO RELATED APPLICATIONS

This application is a continuation in part of U.S. patent application Ser. No. 17/206,110 titled “SYSTEM AND METHOD FOR THOUGHT OBJECT SELECTION BY CUSTOM FILTERING AND COMPUTED DIVERSIFICATION” which was filed on Feb. 18, 2021 which is continuation of U.S. patent application Ser. No. 16/726,826, titled “SYSTEM AND METHOD FOR THOUGHT OBJECT SELECTION” which was filed on Dec. 25, 2019 which is a continuation-in-part of U.S. patent application Ser. No. 15/066,303, titled “PROCESSING QUALITATIVE RESPONSES”, which was filed on Mar. 10, 2016 which is a continuation of International Patent Application No. PCT/CA2014/050889, filed Sep. 17, 2014, which claims priority to each of U.S. Provisional Application No. 61/880,578, filed Sep. 20, 2013, and U.S. Provisional Application No. 61/951,044, filed Mar. 11, 2014, the specifications of each of which are hereby incorporated by reference in their entirety.

### BACKGROUND OF THE INVENTION

### Field of the Art

The disclosure relates to the field of processing qualitative responses from a plurality of user devices, and more particularly to the field of computing and selecting diverse thought objects from plurality of qualitative responses received by plurality of user devices.

### Discussion of the State of the Art

In systems where input from a plurality of user devices is solicited, understanding an effective distribution mechanism of thought objects for solicitation of responses by a plurality of user devices is challenging.

Typically, when results from a plurality of user participant devices are used to gather input on a subject, two different types of participant responses are elicited: quantitative responses and qualitative responses. A quantitative response is a close-ended response, such as a multiple choice, numeric style, or yes/no response. A qualitative response is an open-ended, comment style response, where the participant has freedom to textualize associated ideas and is not constrained by pre-determined answers. Accordingly, eliciting qualitative responses may have substantial benefits over quantitative responses in that qualitative responses can provide more detailed information on participant interests, consisting of areas of alignment, sentiment or topics, to name a few.

However, there are well known limitations with handling, evaluating, and distributing qualitative responses, as compared to quantitative responses. The problem of distributing qualitative responses generalizes to dealing with what a next best qualitative response to display to one or more user devices would be, in order to receive a more complete response pattern by the one or more user devices. Specifically, there is no easy way to ensure that the one or more user devices received a diverse enough set of qualitative responses to have a complete, or near complete view of the subject at hand.

Further according to the art, many online engagement services offer methods of displaying items and information based on previous selections and engagements in a themed fashion, that is, showing future information what has been previously liked or engaged by a user. These systems do not take into consideration a display of a diverse set of information to users.

Accordingly, a need in the art exists for a system and method for computing a distribution pattern of information whereby thought objects are displayed with equal coverage while reducing bias and displaying thought objects representing a diverse range of thoughts to one or more user devices.

### SUMMARY OF THE INVENTION

Accordingly, the techniques described herein relate to a thought selection system including: a thought selection server, including a processor, a memory, and a plurality of programming instructions, the plurality of programming instructions when executed by the processor cause the processor to: receive a plurality of thought objects, wherein the plurality of thought objects includes text present in qualitative responses received from a plurality of user devices, wherein the plurality of thought objects includes M thought objects that are most recently seen thought objects and N thought objects that are least seen by the plurality of user devices; provide, a prompt, to a Large Language Model (LLM) in communication with the thought selection server, wherein the prompt includes a request to identify diverse thought objects and the M thought objects and the N thought objects; compare, the M thought objects and the N thought objects to identify one or more dissimilar thought objects in the N thought objects, wherein comparison is performed based on semantic distances between embeddings associated with the M thought objects and the N thought objects; and select one or more thought objects from the dissimilar thought objects as a diverse thought objects.

In some aspects, the techniques described herein relate to a system, wherein the semantic distances include a cosine distance or Euclidean distance between the embeddings.

In some aspects, the techniques described herein relate to a system, wherein the qualitative responses include one or more text segments present in reviews, survey data, emails, Instant messaging (IM), discussion forums, or any text from communication platforms.

In some aspects, the techniques described herein relate to a computer-implemented method for selection of thought object, the method including: Receive, at a thought selection server, a plurality of thought objects, wherein the plurality of thought objects includes text present in qualitative responses received from a plurality of user devices, wherein the plurality of thought objects includes M thought objects that are most recently seen thought objects and N thought objects that are least seen by the plurality of user devices; provide, a prompt, to a Large Language Model (LLM) in communication with the thought selection server, wherein the prompt includes a request to identify diverse thought objects and the M thought objects and the N thought objects; compare, the M thought objects and the N thought objects to identify one or more dissimilar thought objects in the N thought objects, wherein the comparison is performed based on semantic distances between embeddings associated with the M thought objects and the N thought objects; and select one or more thought objects from the dissimilar thought objects as diverse thought objects.

In some aspects, the semantic distances include a cosine distance or Euclidean distance between the embeddings.

In some aspects, the LLM is a foundation model.

In some aspects, the qualitative responses include one or more text segments present in reviews, survey data, emails, Instant messaging (IM), discussion forums, or any text from communication platforms.

In some aspects, the techniques described herein relate to a thought selection system including: a thought selection server, including a processor, a memory, and a plurality of programming instructions, the plurality of programming instructions when executed by the processor cause the processor to: receive a plurality of thought objects, wherein the plurality of thought objects includes text present in qualitative responses received from a plurality of user devices; generate word embedding for each thought object using a non-transformer based embedding model; and combine, the generated word embeddings to generate embedding per thought object.

In some aspects, the techniques described herein relate to a thought selection system, the plurality of programming instructions when executed by the processor cause the processor to: determine, based on semantic dissimilarity, diverse thoughts present among the plurality of received thought objects, wherein the semantic dissimilarity is identified based on cosine similarity or Euclidean distance.

### BRIEF DESCRIPTION OF THE DRAWING FIGURES

The accompanying drawings illustrate several embodiments of the invention and, together with the description, serve to explain the principles of the invention according to the embodiments. It will be appreciated by one skilled in the art that the particular embodiments illustrated in the drawings are merely exemplary and are not to be considered as limiting of the scope of the invention or the claims herein in any way.

FIG. 1 is a block diagram illustrating an exemplary hardware architecture of a computing device used in an embodiment of the invention;

FIG. 2 is a block diagram illustrating an exemplary logical architecture for a client device, according to an embodiment of the invention;

FIG. 3 is a block diagram showing an exemplary architectural arrangement of clients, servers, and external services, according to an embodiment of the invention;

FIG. 4 is another block diagram illustrating an exemplary hardware architecture of a computing device used in various embodiments of the invention;

FIG. 5 is a plurality of objects used for thought object filtering and selection, according to a preferred embodiment of the invention;

FIG. 6A is a block diagram illustrating an exemplary conceptual architecture of a thought object selection server, according to a preferred embodiment of the invention;

FIG. 6B is an example block diagram of an encoder transformer model and decoder transformer model, in accordance with an embodiment of the invention.

FIG. 6C is an example block diagram depicting the generation of a fine-tuned LLM, in accordance with an embodiment of the invention.

FIG. 7 is a flow diagram illustrating a method for conducting a process to solicit thought objects and priority value responses from a plurality of devices, according to a preferred embodiment of the invention;

FIG. 8 is a flow diagram illustrating a method for thought object selection based on a plurality of filtering and selection methods, according to a preferred embodiment of the invention;

FIG. 9 is a flow diagram illustrating a method for filtering a plurality of thought object based on a plurality of custom selection rules, according to a preferred embodiment of the invention;

FIG. 10 is a flow diagram illustrating a method for filtering a plurality of thought objects by computing one or more thought objects that were least displayed to an output device of a user device, according to a preferred embodiment of the invention;

FIG. 11 is a flow diagram illustrating a method for filtering a plurality of thoughts based on a topic calculation, according to a preferred embodiment of the invention;

FIG. 12 is a flow diagram illustrating a method for calculating a topic vector, according to a preferred embodiment of the invention.

FIG. 13 is a flow diagram illustrating a method for determining embeddings in thought objects, according to a preferred embodiment of the invention.

FIG. 14 is a flow diagram illustrating a method for determining diverse thought objects, according to an embodiment of the invention.

### DETAILED DESCRIPTION

The inventor has conceived, and reduced to practice, a system and method for computing a selection of a one or more thought objects for distribution to a plurality of user devices whereby the one or more thought objects provide equal coverage while reducing bias and comprise thought objects representing a diverse range of thoughts.

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

### Definitions

A priority value, as referred to herein, is a response received from a user device and may be a scale represented by one or more stars, representations, or numbers (such as a Likert scale or a zero-centered scale, or the like). In some embodiments, a zero-priority value is a value usable by the system. In some embodiments, the scale is normalized, in other embodiments the scale is a standard scale that may or may not include negative values. In other embodiments, a priority value scale may be a plurality of graphical elements indicating a spectrum of dislike to like, interest or sentiment level, or the like). In some embodiments, graphical scales are converted to a numeric scale for calculation purposes.

In some embodiments, assigned, as referred to herein, for example, with respect to a participant object 575 assigning a priority value to a thought object, may refer to priority values that may have been received by a device 620 and associated to a thought object 510, the device 620 associated to the participant object 575.

Rating, as referred to herein, may be a priority value response received from a device 620 associated to a participant object 575. Ratings may be a numeric value on a scale indicating a range of possible responses available to assign to a thought object 510.

### Hardware Architecture

Generally, the techniques disclosed herein may be implemented on computing hardware or a combination of programming instructions and hardware to form a specially programmed computer. For example, they may be implemented in an operating system kernel, in a separate user process, in a library package bound into network applications, on a specially constructed machine, on an application-specific integrated circuit (ASIC), or on a network interface card.

An implementation based on programming instructions and hardware may describe at least some of the embodiments disclosed herein and may be implemented on a programmable network-resident machine (which should be understood to include intermittently connected network-aware machines) selectively activated or reconfigured by computer program instructions stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, wearable device, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

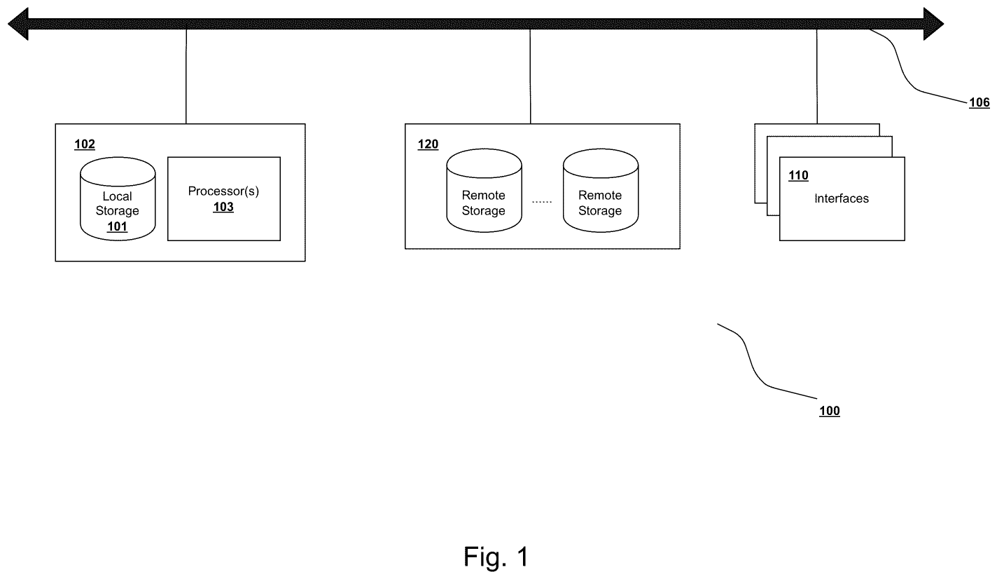

Referring now to FIG. 1, there is shown a block diagram depicting an exemplary computing device 100 suitable for implementing at least a portion of the features or functionalities disclosed herein. Computing device 100 may be, for example, any one of the computing machines listed in the previous paragraph, or indeed any other electronic device capable of executing software- or hardware-based instructions according to one or more programs stored in memory. Computing device 100 may be adapted to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 100 includes one or more central processing units (CPU) 102, one or more interfaces 110, and one or more busses 106 (for example, a peripheral component interconnect (PCI) bus). When acting under the control of appropriate software or firmware, CPU 102 (i.e. processor) may be responsible for implementing specific functions associated with the functions of a specifically configured computing device or machine. For example, in at least one embodiment, a computing device 100 may be configured or designed to function as a server system utilizing CPU 102, local memory 101 and/or remote memory 120, and interface(s) 110. In at least one embodiment, CPU 102 may be caused to perform one or more of the different types of functions and/or operations under the control of software modules or components, which for example, may include an operating system and any appropriate applications software, drivers, and the like.

CPU 102 may include one or more processors 103 such as, for example, a processor from one of the Intel, ARM, Qualcomm, and AMD families of microprocessors. In some embodiments, processors 103 may include specially designed hardware such as application-specific integrated circuits (ASICs), electrically erasable programmable read-only memories (EEPROMs), field-programmable gate arrays (FPGAs), and so forth, for controlling operations of computing device 100. In a specific embodiment, a local memory 101 (such as non-volatile random-access memory (RAM) and/or read-only memory (ROM), including for example one or more levels of cached memory) may also form part of CPU 102. However, there are many ways in which memory may be coupled to system 100. Memory 101 may be used for a variety of purposes such as, for example, caching and/or storing data, programming instructions, and the like. It should be further appreciated that CPU 102 may be one of a variety of system-on-a-chip (SOC) type hardware that may include additional hardware such as memory or graphics processing chips, such as a Qualcomm SNAPDRAGON™ or Samsung EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 110 are provided as network interface cards (NICs). Generally, NICs control the sending and receiving of data packets over a computer network; other types of interfaces 110 may for example support other peripherals used with computing device 100. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (Wi-Fi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 110 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 1 illustrates one specific architecture for a computing device 100 for implementing one or more of the inventions described herein, it is by no means the only device architecture on which at least a portion of the features and techniques described herein may be implemented. For example, architectures having one or any number of processors 103 may be used, and such processors 103 may be present in a single device or distributed among any number of devices. In one embodiment, single processor 103 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 120 and local memory 101) configured to store data, program instructions for the general-purpose network operations, or other information relating to the functionality of the embodiments described herein (or any combinations of the above). Program instructions may control execution of or comprise an operating system and/or one or more applications, for example. Memory 120 or memories 101, 120 may also be configured to store data structures, configuration data, encryption data, historical system operations information, or any other specific or generic non-program information described herein.

Because such information and program instructions may be employed to implement one or more systems or methods described herein, at least some network device embodiments may include non-transitory machine-readable storage media, which, for example, may be configured or designed to store program instructions, state information, and the like for performing various operations described herein. Examples of such non-transitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a Java™ compiler and may be executed using a Java virtual machine or equivalent, or files containing higher level code that may be executed by the computer using an interpreter (for example, scripts written in Python, Perl, Ruby, Groovy, or any other scripting language).

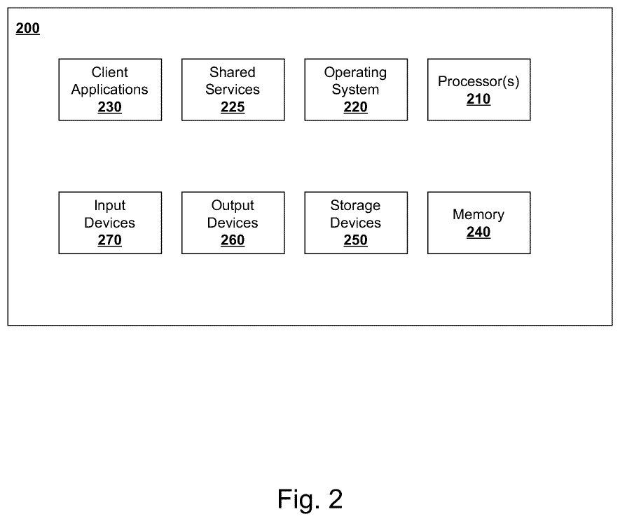

In some embodiments, systems according to the present invention may be implemented on a standalone computing system. Referring now to FIG. 2, there is shown a block diagram depicting a typical exemplary architecture of one or more embodiments or components thereof on a standalone computing system. Computing device 200 includes processors 210 that may run software that carry out one or more functions or applications of embodiments of the invention, such as for example a client application 230. Processors 210 may carry out computing instructions under control of an operating system 220 such as, for example, a version of Microsoft's WINDOWS™ operating system, Apple's Mac OS/X or iOS operating systems, some variety of the Linux operating system, Google's ANDROID™ operating system, or the like. In many cases, one or more shared services 225 may be operable in system 200 and may be useful for providing common services to client applications 230. Services 225 may for example be WINDOWS™ services, user-space common services in a Linux environment, or any other type of common service architecture used with operating system 210. Input devices 270 may be of any type suitable for receiving user input, including for example a keyboard, touchscreen, microphone (for example, for voice input), mouse, touchpad, trackball, or any combination thereof. Output devices 260 may be of any type suitable for providing output to one or more users, whether remote or local to system 200, and may include for example one or more screens for visual output, speakers, printers, or any combination thereof. Memory 240 may be random-access memory having any structure and architecture known in the art, for use by processors 210, for example to run software. Storage devices 250 may be any magnetic, optical, mechanical, memristor, or electrical storage device for storage of data in digital form (such as those described above, referring to FIG. 1). Examples of storage devices 250 include flash memory, magnetic hard drive, CD-ROM, and/or the like.

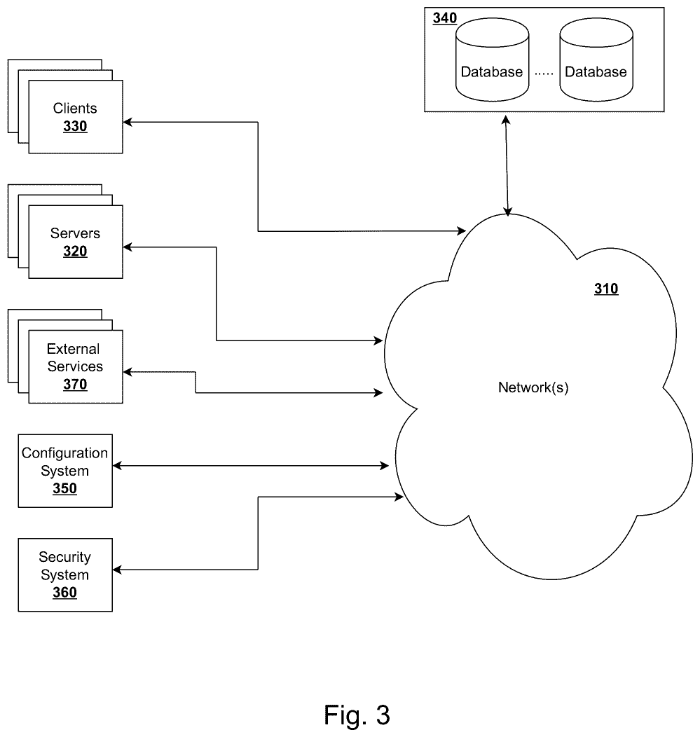

In some embodiments, systems of the present invention may be implemented on a distributed computing network, such as one having any number of clients and/or servers. Referring now to FIG. 3, there is shown a block diagram depicting an exemplary architecture 300 for implementing at least a portion of a system according to an embodiment of the invention on a distributed computing network. According to the embodiment, any number of clients 330 may be provided. Each client 330 may run software for implementing client-side portions of the present invention; clients may comprise a system 200 such as that illustrated in FIG. 2. In addition, any number of servers 320 may be provided for handling requests received from one or more clients 330. Clients 330 and servers 320 may communicate with one another via one or more electronic networks 310, which may be in various embodiments any of the Internet, a wide area network, a mobile telephony network (such as CDMA or GSM cellular networks), a wireless network (such as Wi-Fi, WiMAX, LTE, and so forth), or a local area network (or indeed any network topology known in the art; the invention does not prefer any one network topology over any other). Networks 310 may be implemented using any known network protocols, including for example wired and/or wireless protocols.

In addition, in some embodiments, servers 320 may call external services 370 when needed to obtain additional information, or to refer to additional data concerning a particular interaction. Communications with external services 370 may take place, for example, via one or more networks 310. In various embodiments, external services 370 may comprise web-enabled services or functionality related to or installed on the hardware device itself. For example, in an embodiment where client applications 230 are implemented on a smartphone or other electronic device, client applications 230 may obtain information stored in a server system 320 in the cloud or on an external service 370 deployed on one or more of a particular enterprises or user's premises.

In some embodiments of the invention, clients 330 or servers 320 (or both) may make use of one or more specialized services or appliances that may be deployed locally or remotely across one or more networks 310. For example, one or more databases 340 may be used or referred to by one or more embodiments of the invention. It should be understood by one having ordinary skill in the art that databases 340 may be arranged in a wide variety of architectures and using a wide variety of data access and manipulation means. For example, in various embodiments one or more databases 340 may comprise a relational database system using a structured query language (SQL), while others may comprise an alternative data storage technology such as those referred to in the art as “NoSQL” (for example, Hadoop Cassandra, Google BigTable, and so forth). In some embodiments, variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database,” it should be construed to mean any of these senses of the word, all of which are understood as a plain meaning of the term “database” by those having ordinary skill in the art.

Similarly, most embodiments of the invention may make use of one or more security systems 360 and configuration systems 350. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 360 or configuration system 350 or approach is specifically required by the description of any specific embodiment.

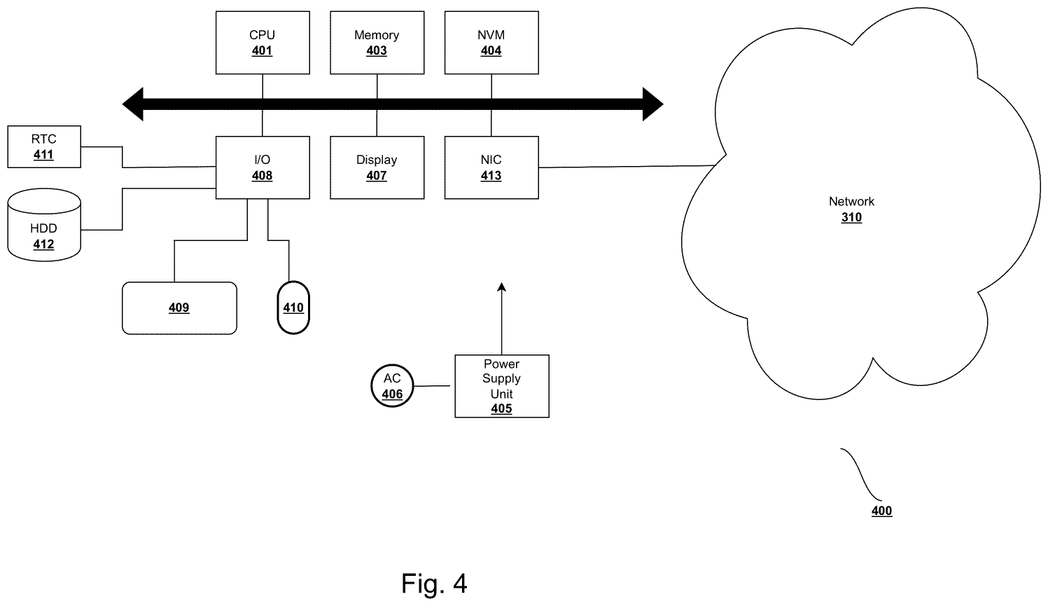

FIG. 4 shows an exemplary overview of a computer system 400 as may be used in any of the various locations throughout the system. It is exemplary of any computer that may execute code to process data. Various modifications and changes may be made to computer system 400 without departing from the broader spirit and scope of the system and method disclosed herein. CPU 401 is connected to bus 402, to which bus is also connected memory 403, nonvolatile memory 404, display 407, I/O unit 408, and network interface card (NIC) 413. I/O unit 408 may, typically, be connected to keyboard 409, pointing device 410, hard disk 412, and real-time clock 411. NIC 413 connects to network 310, which may be the Internet or a local network, which local network may or may not have connections to the Internet. Also shown as part of system 400 is power supply unit 405 connected, in this example, to ac supply 406. Not shown are batteries that could be present, and many other devices and modifications that are well known but are not applicable to the specific novel functions of the current system and method disclosed herein. It should be appreciated that some or all components illustrated may be combined, such as in various integrated applications (for example, Qualcomm or Samsung SOC-based devices), or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of the present invention may be distributed among any number of client and/or server components. For example, various software modules may be implemented for performing various functions in connection with the present invention, and such modules may be variously implemented to run on server and/or client components.

### Prompt Creation for Diverse Thought Object Selection

The prompts provided to the Large Language Model (LLM) play a crucial role in guiding the selection of diverse thought objects. These prompts are carefully constructed to steer the LLM towards identifying thought objects that represent different perspectives, opinions or topics compared to those recently seen with users.

The prompts may be created manually by system operators or generated automatically based on heuristics and templates. In a preferred embodiment, formulating prompts comprise:
Specifying the desired output of diverse thought objects.
Providing context about recently seen objects and less seen objects.
Using concise and unambiguous language that an LLM will reliably interpret.
Employing techniques like few-shot learning to prime the LLM with examples of diverse outputs.

In some embodiment, a format and content of the prompts may vary depending on the specific LLM being used and the domain of the thought objects. However, the prompts aim to elicit thought objects that are semantically dissimilar to recently seen ones and broaden the range of perspectives presented to users.

In one embodiment, prompts are systematically constructed using the following process:

Identify key characteristics of recently seen thought objects (M) and less seen objects (N), such as dominant topics, sentiment, writing style, etc. This may be done using techniques like topic modeling, sentiment analysis and stylometric analysis.

Formulate a prompt template that juxtaposes these characteristics and requests diverse alternatives. For example: “Generate thought objects that are diverse and discuss different topics.”

Instantiate the template with the specific characteristics of the current M and N object sets: “The recently seen thought objects cover topics politics, economy, environment and generally express positive sentiment. The less seen objects mostly have a formal writing style. Generate thought objects that discuss different topics like art, science, culture, express negative or neutral sentiment, and use a more casual tone.”

Provide additional instructions or examples to clarify the task: Focus on selecting thought objects that offer novel perspectives compared to the recently seen ones. For instance:

Recent object: I believe the new economic policy will lead to growth and prosperity.

Diverse object: The arts are severely underfunded-we need to rethink our priorities as a society.

Recent object: The proposed environmental regulations will harm businesses and cost jobs.

Diverse object: Advances in renewable energy technology offer exciting opportunities for the future.

Adjust the prompt template and examples based on the LLM's outputs to iteratively improve performance.

LLM consistently selects thought objects that are diverse in topic, sentiment, style and other relevant attributes. The specific prompts will vary depending on the LLM and the domain of the thought objects, but the general principles of providing clear instructions, and iterative refinement based on outputs apply across embodiments.

The diverse thought objects computed and processed using techniques described herein are ultimately displayed to users via their devices, exposing them to a broader range of perspectives beyond the most recently seen content. This encourages users to consider different viewpoints and engage with a more heterogeneous set of ideas.

### Providing Context in Prompts

To effectively guide an LLM towards selecting diverse thought objects, techniques described herein may provide rich context about the recently seen and less seen object sets in the prompts. This context may help the LLM understand the nuances and distinctions between the two sets, enabling it to make more informed and targeted selections.

There are several types of contexts that can be provided in the prompts, including, but not limited to:

Metadata-based Context: Metadata associated with the thought objects can be used to provide context in the prompts. This metadata may include information such as timestamp (when the thought object was created or shared), user data (demographics, location, interests of the user who created/shared the object), and engagement metrics (number of views, quantitative responses, comments, shares, etc.). This metadata can be incorporated into prompts to help the LLM understand the context and characteristics of recently seen vs. less seen objects. For example: “The recently seen thought objects were mostly created by users in the 18-24 age group and received an average of 4 quantitative responses. The less seen objects are older, created by users in the 35+ age group, and have fewer than 2 quantitative responses on average.”

Semantic Context: Semantic context about the thought objects can be provided in the prompts by extracting key phrases, named entities, or themes from the objects' text; performing sentiment analysis or emotion detection on the text; and identifying the linguistic style, readability, or complexity of the text. These semantic features can be summarized in the prompts to give the LLM a sense of the content and tone of the thought objects. For instance: “The recently seen thought objects frequently mention entities like ‘COVID-19’, ‘remote work’, and ‘economic impact’, and have a slightly negative average sentiment. The less seen objects cover a wider range of topics and have a more neutral sentiment on average.”

Domain-specific Context: Domain-specific knowledge or ontologies can be used to provide rich context about the thought objects. For example, in a news aggregation system, the prompts could mention the categories, sources, or geographies covered by the object sets. In a product review platform, the prompts could describe the product categories, brands, or features mentioned in the reviews. In a social media feed, the prompts could include context about the trending hashtags, memes, or influencers related to the posts. Incorporating this domain-specific context into prompts can help guide the LLM's selections based on the nuances and priorities of the specific use case.

By incorporating these various types of contextual data-metadata, semantics, comparisons, domain knowledge-into the prompts, the LLM gains a rich, multi-dimensional understanding of the recently seen vs. less seen content. This comprehensive context enables the LLM to make more nuanced and effective selections of diverse thought objects, tailored to the specific characteristics and differences between the input sets.

By providing this rich, multi-dimensional context about the input thought object sets, the LLM can more effectively understand the nuances and distinctions between the recently seen and less seen content, enabling it to select diverse thought objects that expand the range of perspectives presented to users.

Here is a suggested disclosure for “Using concise and unambiguous language that the LLM will reliably interpret”:

### Concise Prompt Creation

Systems and methods described herein construct concise prompts to guide the LLM's selection of diverse thought objects, it's essential to use language that is clear, concise, and unambiguous. The LLM's ability to reliably interpret and follow the prompts is guided by the clarity and specificity of the instructions provided.

To ensure that the LLM can accurately understand and respond to the prompts, the systems and methods described herein:

Use simple and direct language: Prompts may be written in plain, straightforward language that avoids complex vocabulary, jargon, or convoluted sentence structures. The system communicates the instructions as clearly and simply as possible, reducing the potential for misinterpretation.

Prompts are generated to be specific and explicit: Prompts provide specific, explicit instructions about what the LLM is expected to do. The prompts clearly define the criteria for selecting diverse thought objects, such as the desired topics, sentiments, styles, or other characteristics.

Prompts are not created in an ambiguous or vague pattern: Prompts are carefully worded, by the systems described herein to avoid ambiguity or vagueness that could lead to multiple interpretations. Each instruction comprises a single, clear meaning that the LLM can reliably act upon. If multiple interpretations are possible, the prompt may be reworded to eliminate the ambiguity. In some embodiments, this may happen iteratively

Consistent terminology: Prompts generated using systems described herein comprise consistent terminology throughout to refer to key concepts, entities, or attributes.

Examples of a clear, concise, and unambiguous prompt may include: “Select a thought object from the less seen set that discusses a topic not mentioned in the recently seen objects. The selected object should have a neutral sentiment and be written in an informative style. Avoid objects with negative sentiment or a persuasive tone.”

Accordingly, this exemplary prompt provides specific instructions about the topic, sentiment, and style of the desired thought object, while also explicitly stating what to avoid. This prompt uses simple language and concrete criteria, it leaves little room for misinterpretation.

Prompts may be generated in a way that is easily interpretable by the LLM, leading to more accurate and consistent selection of diverse thought objects. Clear, concise, and unambiguous prompts are essential for ensuring that the LLM can reliably follow the intended instructions and generate the desired output.

Here's a detailed disclosure on “Employing techniques like few-shot learning to prime the LLM with examples of diverse outputs”:

### Priming an LLM

In a preferred embodiment, guiding LLMs to generate diverse thought objects may comprise few-shot learning. Few-shot learning involves providing the LLM with a small number of exemplary input-output pairs that demonstrate the desired behavior or characteristics. By priming the LLM with these examples, it can quickly adapt its language understanding and generation capabilities to align with the specific task at hand.

In the context of diverse thought object selection, few-shot learning may be used to prime the LLM with examples of diverse outputs. These examples serve as a form of conditioning, showing the LLM the types of thought objects that are considered diverse in relation to the recently seen ones.

Prompt: Select a thought object from the less seen set that discusses a different topic and may have a contrasting sentiment to the recently seen thought object.

The exact format may vary depending on the LLM architecture and prompt design, systems described herein provide clear, consistent examples that the LLM can learn from.

Prepend the examples to the actual prompt: When constructing the prompt for a specific set of recently seen and less seen objects, prepend the curated examples as a prefix to the main prompt. This allows the LLM to first process the examples and adapt its understanding of diversity based on the provided input-output pairs.

Fine-tune the LLM. In some embodiments, if the LLM supports fine-tuning, the curated examples may be used as a small training dataset to further specialize the model for the task of diverse thought object selection. Fine-tuning can help the LLM internalize the patterns and characteristics of diverse outputs more deeply, leading to improved performance on the specific task.

By employing few-shot learning in this manner, the LLM can be primed with concrete examples of what constitutes a diverse thought object in the context of the given recently seen and less seen sets. The examples serve as a form of explicit guidance, demonstrating the desired output characteristics and helping the LLM generate selections that align with those criteria.

As the LLM processes the examples, it learns to recognize the patterns and attributes that distinguish diverse thought objects from the recently seen ones. This priming effect helps the LLM internalize the concept of diversity in the specific context of the application, enabling it to make more relevant and accurate selections when presented with new sets of thought objects.

Few-shot learning is particularly advantageous when working with large, pre-trained LLMs that have a broad knowledge base spanning various domains. By providing a small number of task-specific examples, these models can quickly adapt their existing knowledge and capabilities to the precise requirements of diverse thought object selection, without the need for extensive fine-tuning or retraining.

Moreover, the examples used in few-shot learning can be carefully curated and updated over time based on feedback and evaluation of the LLM's outputs. By refining the examples to better capture the nuances of diversity in different contexts and domains, the LLM's performance can be continually and iteratively improved and optimized for the specific use case.

Overall, employing few-shot learning to prime LLMs with examples of diverse outputs is a powerful technique for guiding the selection of thought objects that offer fresh perspectives and divergent viewpoints compared to recently seen content. By providing explicit, concrete examples of diversity, LLMs can more reliably and accurately identify and surface thought objects that enrich the user's information diet and promote exposure to a wider range of ideas and opinions.

### Conceptual Architecture

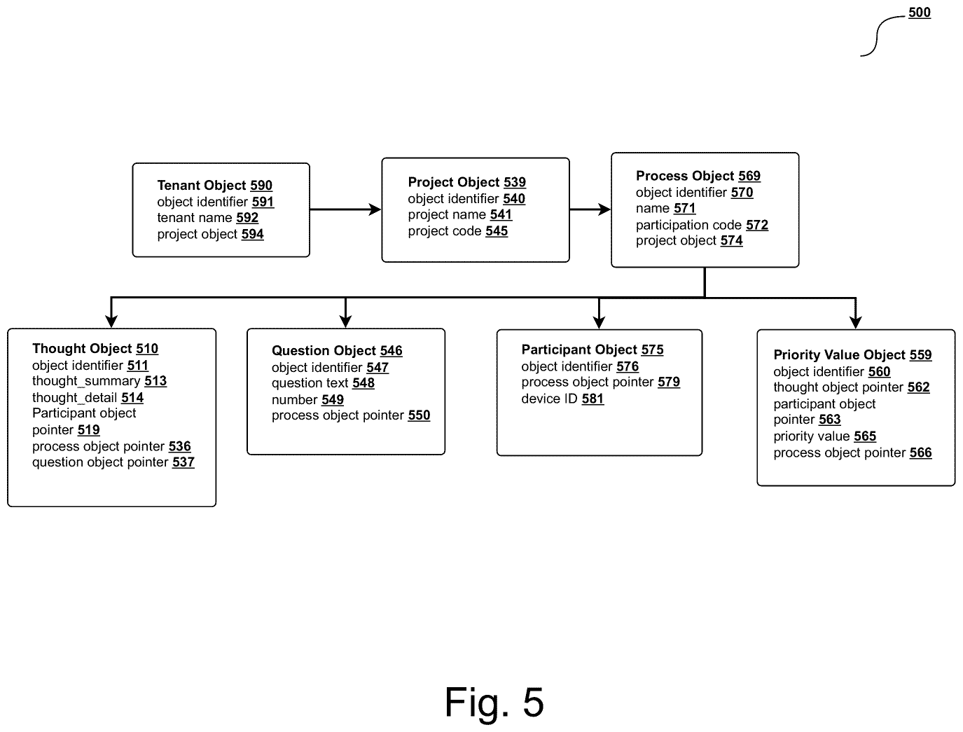

FIG. 5 is a plurality of objects used for thought object filtering and selection, according to a preferred embodiment of the invention. According to the embodiment, a plurality of programming instructions stored in memory 240 that when executed by at least one processor 210 comprise a plurality of objects that may comprise data, in the form of fields, often known as attributes and programming instructions, in the form of procedures, often known as methods. Objects 500 may be arranged such that procedures can access and often modify one or more data fields of an associated object. In various embodiments, programming instructions enable objects to interact with one another. In a preferred embodiment, objects 500 may be implemented in an object-relational database management system, for example PostgreSQL.

Accordingly, It can be appreciated that an understanding of a plurality of priority values received from a plurality of participant devices 620 provides a means for large scale involvement of users via devices 620 in a networked environment to participate in a quantitative fashion to evaluate thoughts that require an understanding of interest regardless of device location, temporal displacement (i.e. when the respondents responded), psychology (willingness to provide responses in an open forum, or requirement for anonymity), and the like. An interest categorization may represent a collective understanding of what may be most important to at least a portion of a group of users associated to devices 620, for example, across dispersed groups such that understanding of concepts and perspective using accurate priority-based indicators from a plurality of participant devices 620 by a plurality of users.

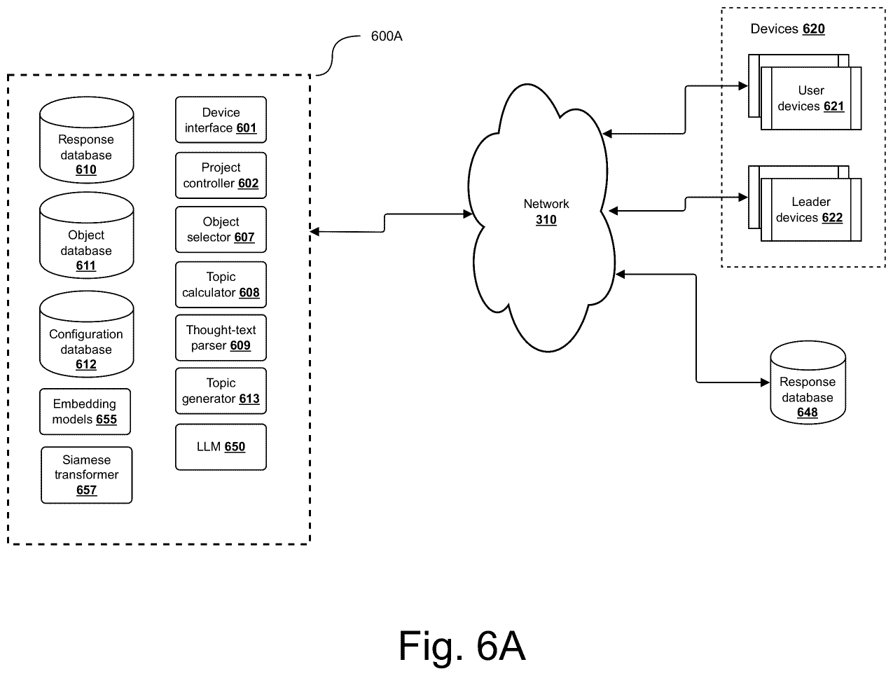

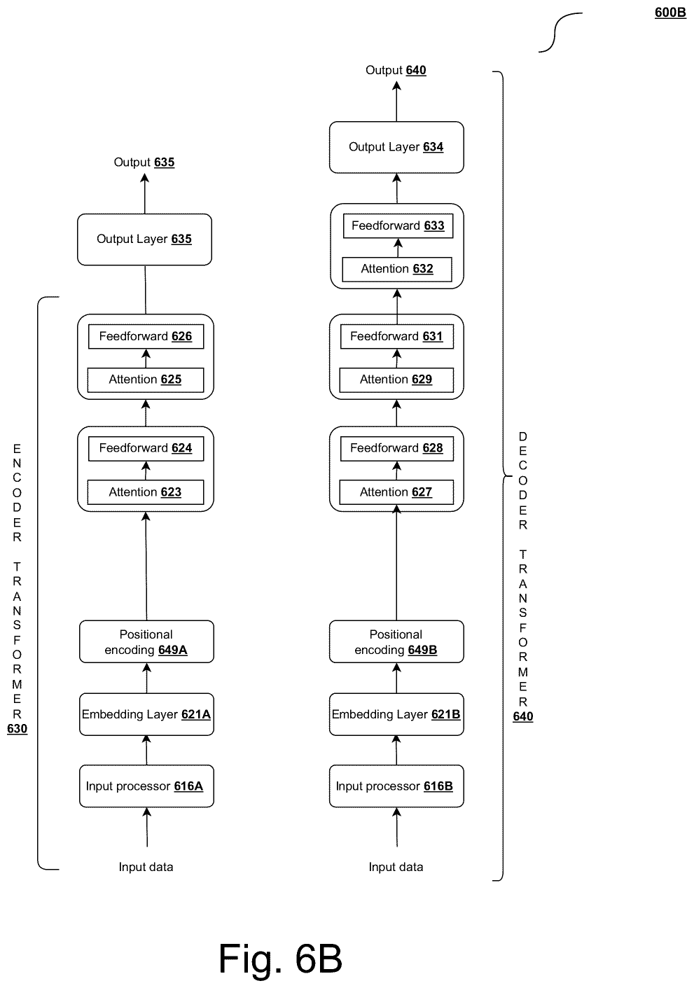

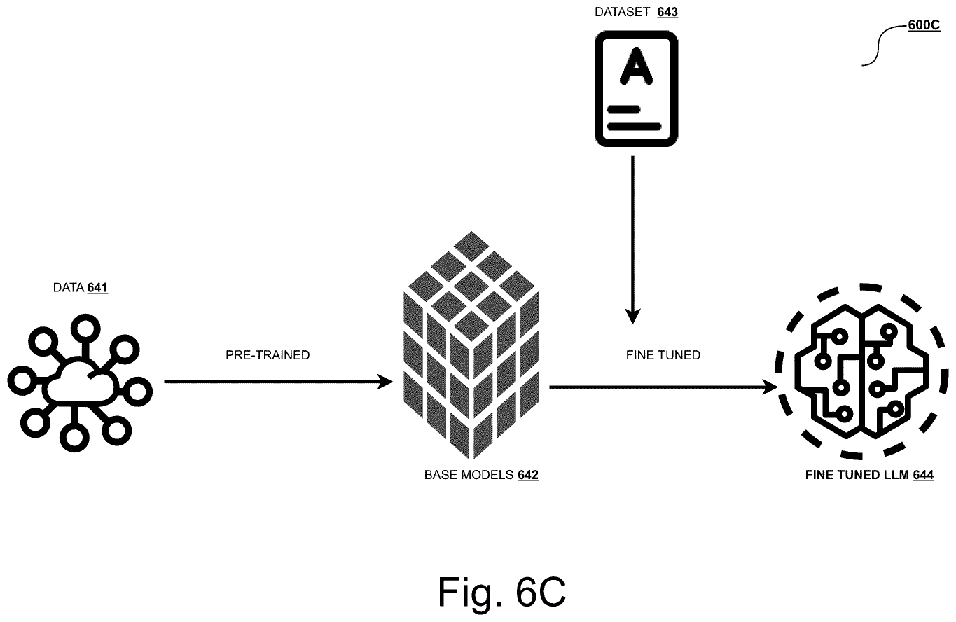

Tenant object 590 may be a plurality of programming instructions stored in memory 240 that when executed by one or more processors 210 describe a tenant of system 600A, that is, a configured entity that may execute a plurality of projects described by one or more associated project objects 539 for analysis of interest for a plurality of priority values received from a plurality of participant devices 620 associated to one or more thought objects 510. Accordingly, one or more project objects 539, that are associated to the tenant object 590, are connected by project object pointer 594. In a preferred embodiment, tenant object 590 may comprise: an object identifier 591 whereby each instantiation of tenant object 590 may be referred to uniquely within the system; tenant name 592 may be a text description of the instant tenant object 590; project object pointer 594 (described above) comprises one or more pointers to one or more project objects 539. Said differently, system 600A may configure multiple tenant objects 590 whereby each tenant object 590 may be associated to a plurality of project objects 539 whereby each associated project object 539 is associated to a plurality of other objects 500 (depicted in FIG. 5) to enable analysis of qualitative patterns for a plurality of priority values received from a plurality of participant devices 620. It should be appreciated that participant devices 620 may be at least a portion of devices 620. In a preferred embodiment, participant devices 620 may be devices that, through network 310, provided responses to, for example, a question object 546 and/or thought objects 510. In some embodiments, leader devices 622 (referring to FIG. 6A) may be considered participant devices 620.

Project object 539 may be a plurality of programming instructions stored in memory 240 that when executed by processors 210 describe a project for an analysis of qualitative patterns for a plurality of priority values received from a plurality of participant devices 620 based on one or more thought objects 510 whereby a project may be a planned collaborative executions of the methods described herein utilizing one or more specially programmed components 600A (referring to FIG. 6A). Project object 539 may comprise: object identifier 540 which may be a globally unambiguous persistent identifier representing an instance of project object 539; project name 541 may be textual description of the instance of the project object 539; project code 545 may be unique identifier associated to a project object 539. Thought object 510 may be a plurality of programming instructions stored in memory 240 that when executed by processors 210 comprise an arrangement of information in the form of ideas received from a device 620 whereby an analysis of qualitative patterns for a plurality of priority values received in response to the arrangement of information from a plurality of participant devices 620. Thought object 510 may comprise: object identifier 511 which may be a globally unambiguous persistent identifier representing an instance of thought object 510; thought_summary 513 may be an arrangement of information corresponding to a qualitative response from a device 620 to another arrangement of information in the form of an open-ended question from, for example, a question object 546; thought_detail 514 may be an additional arrangement of information corresponding to an additional qualitative response from a device 620, for example, an explanation of the importance of the qualitative response represented by thought_summary 513; shared_by 519 is a pointer to a participant object 575 who shared the instant thought object 510; process object pointer 536 may be a pointer to an associated process object 569; question 537 may be a pointer to an associated question object 546 to, for example, have access to the question object 546 through its memory address instead of a new object being created on a stack.

Question object 546 may be a plurality of programming instructions stored in memory 240 that when executed by processors 210 comprise details around the associated arrangement of information associated to a corresponding an open-ended question by, for example, as configured by a leader device 622, the arrangement of information being a point of origination for which a plurality of thought objects 510 result, are distributed by project controller 602, and for which a plurality of priority value responses are solicited from at least a portion of devices 620 to perform an analysis of qualitative patterns. Question object 546 may comprise, at least: object identifier 547 which may be a globally unambiguous persistent identifier representing an instance of question object 546; question text 548 may be an arrangement of information comprising textual description in the form of an open-ended question; number 549 may be an additional unique identifier for the instant question object 546 that may indicate an index of the instant question in a sequence or series of related question objects in a project object 539; process object pointer 550 may be a pointer to an associated process object 569, for example, to have access to the process object 569 through its memory address instead of a new object being created on a stack.

Priority value object 559 may be a plurality of programming instructions stored in memory 240 that when executed by processors 210 comprise an object describing details around a priority value received from a participant device 620. It should be noted that in a typical analysis, a plurality of priority value objects may be associated to a thought object 510 for an analysis of qualitative patterns as described throughout this specification. Priority value object 559 may comprise: object identifier 560 which may be a globally unambiguous persistent identifier representing an instance of priority value object 559; thought object 562 may be a pointer to a corresponding thought object 510, for example, to have access to the an associated thought object 510 through its memory address instead of a new object being created on a stack; participant 563 is a pointer to Participant object 575 that assigned priority value 565 (mentioned below); priority value 565 may be a numeric identifier of the priority value received from a corresponding participant device 620 associated to the participant object 575 referenced in participant pointer 563 (in some embodiments, priority value 565 may be an alphanumeric value, a Boolean, an identifier to an emoticon or some other graphical representation, or the like); process object 566 may be a pointer to a process object 569 to, for example, have access to the process object 569 through its memory address instead of a new object being created on a stack.

Process object 569 may be a plurality of programming instructions stored in memory 240 that when executed by processors 210 comprise an object describing a process corresponding to a project object 539 for an analysis of qualitative patterns. A process may provide a procedure for how a project is to be executed, for example, how thought objects 510 will be distributed, how responses are received and processed, and the like. Process object 569 may comprise: object identifier 570 which may be a globally unambiguous persistent identifier representing an instance of process object 569; name 571 may be textual description of the instance of the process object 569; number 572 may be an additional unique identifier associated to the instant process object 569; project object 574 may be a pointer to a corresponding project object 539 to, for example, have access to the project object 539 through its memory address instead of a new object being created on a stack.

Participant object 575 may be a plurality of programming instructions stored in memory 240 that when executed by processors 210 comprises an object to describe a participant associated to a participant device 620 (that is, each participant object corresponds to a corresponding device 620). In some embodiments, participant objects may be assigned to devices 620 that have participated (for example, provided priority values to one or more thought objects, or provided one or more thought objects 510 in response to a question object 546). Participant object 575 may comprise, at least: object identifier 576 which may be a globally unambiguous persistent identifier representing an instance of participant object 575; process object 579 may be a pointer to an associated process object 569 to, for example, have access to the process object 569 through its memory address instead of a new object being created on a stack; project object 580 may be a pointer to a project object 539 to, for example, have access to the project object 539 through its memory address instead of a new object being created on a stack; device ID identifies an associated user device 620.

It should be noted that, in a preferred embodiment, a tenant object 590 may represent properties and methods corresponding to a user, or group of users, of the system (for example, a company, organization, or the like). Each tenant object 590 may be associated to one or more project object 539 that may provide details around a project for exchanging information following one or more processes associated to one or more process objects 569 whereby at least one question object 546 and a plurality of thought objects 510 describe an interaction by devices 620 (at least a portion of which are associated to a participant objects 575) whereby interaction comprises, at least, an assignment of priority values 559 to thought objects 510.

FIG. 6A is a block diagram illustrating an exemplary conceptual architecture of a thought object selection server, according to a preferred embodiment of the invention. According to the embodiment, thought object selection system 600A comprises a plurality of components each comprising at least a plurality of programming instructions, the programming instructions stored in memory 240 that when executed by one or more processors 210, cause one or more processor 210 to perform operations disclosed herein. In a preferred embodiment, a question object 546 is received at a project controller 709 from a first leader device 622. The question object 546 may then be distributed, by project controller 602 to at least a portion of a plurality of devices 620, subsequently, a plurality of thought objects 510 may be received from at least a portion of the at least portion of the plurality of devices 620 whereby the thought objects 510 may be redistributed to at least a portion of the plurality of devices 620 with a request for an assignment, by at least a portion of the plurality of user participant devices 620, of one or more priority values. It should be appreciated that questions objects 546 when received from a leader device 622, the objects and associated parameters may be stored in object database 611. Similarly, thought objects 510 received from the at least portion of the at least portion of the plurality of devices 620 may be stored in object database 611. In some embodiments, one or more priority value objects 559 comprising the one or more priority values associated to a corresponding thought object 510 of the plurality of thought objects 510 are received by one or more devices 620. In some embodiments, project controller 602 processes methods herein based at least in part on configuration within project object 539 and process object 569.

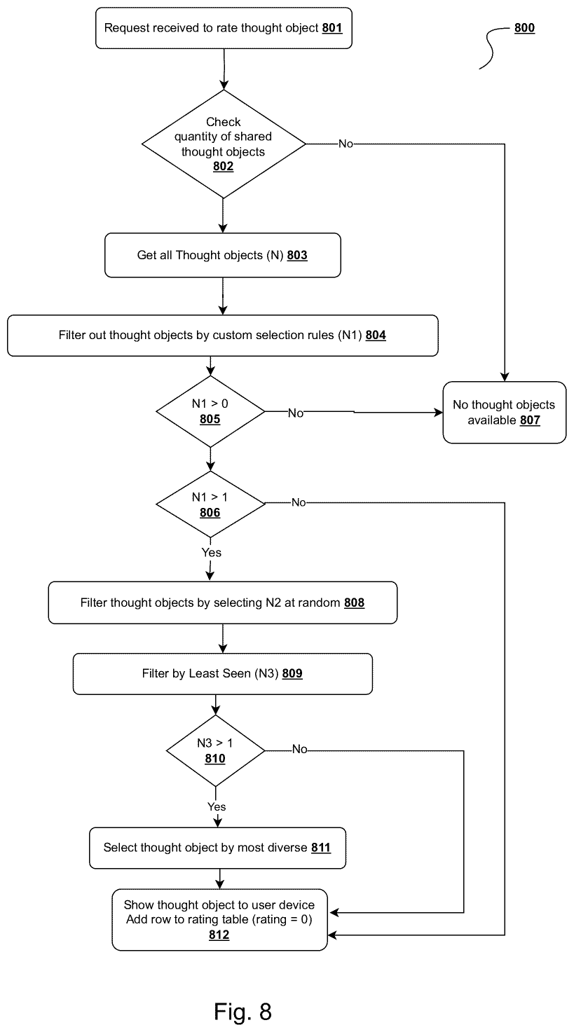

Prior to project controller 602 processing the plurality of priority value objects 559 for the plurality of thought objects 510 from the plurality of devices 620, object selector 607 may use algorithms described herein (referring to FIGS. 8-12) to filter and select objects for distribution to one or more devices 620. It should be appreciated that question object 546 and at least a portion of the plurality of thought objects (and associated other objects 500) are associated to at least one project object 539. In a preferred embodiment, a tenant object 590 may have one or more associated projects 539, that is, that a tenant may perform a plurality of mutually exclusive projects (also referred to herein as an exchange) to understand the dynamics and behaviors of a plurality of users via a plurality of devices. Though in a preferred embodiment, projects are self-contained in nature (in terms of analyses that are performed), it should be appreciated that in some embodiments, projects may be interrelated, and calculations by system 600A, may be performed across a plurality of projects.

According to some embodiments, each thought object 510 must meet certain criteria in order to qualify for inclusion into a filter and select computation. These criteria are combinations of meeting (or failing to meet) certain thresholds, as analyzed by thought-text parser 609, topic calculator 608 and object selector 607.

Device interface 601 may manage input/output communications to devices 620, and in some embodiments, to response database 630, over network 310.

Project controller 602 manages an execution of a thought object exchange project whereby project controller 602 may manage receiving and distributing question objects 546 to devices 620, manage receiving and distributing thought objects 510, and receiving and distributing priority value objects 559 via device interface 601.

In a preferred embodiment, object selector 607 filters and selects one or more thought objects 510 for distribution to one or more devices 620. Techniques for filtering and selection by objects selector 607 may include, but not limited to, diversity of thought object 510 based on an analysis of thought object 510 topics, frequency of delivery of a thought object 510 to one or more devices 620, random selection, and the like.

In a preferred embodiment topic calculator 608 may be used by methods disclosed herein to compute a topic of which text within one or more thought objects 510 may represent, that is, quantitatively determine a computed difference between a plurality of thought objects 510 based on informational contents within one or more thought object 510. Further to the embodiment, topic calculator 608 may calculate topic vectors and topic tables using methods described herein.

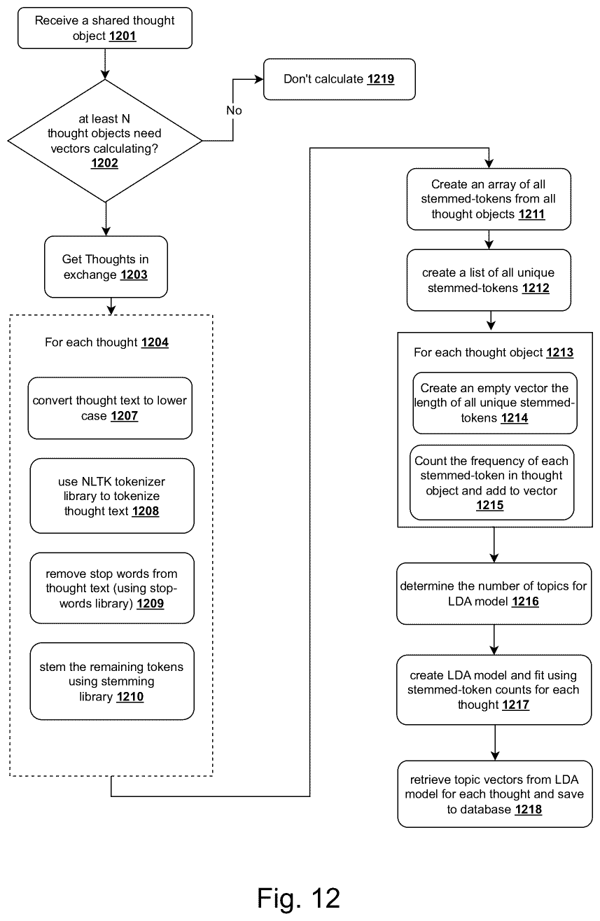

In a preferred embodiment, thought-text parser 609 may generate a plurality of text based on a vocabulary, the vocabulary generated by parsing text from one or more thought objects 510 (for example, from thought_summary 513 and/or thought_detail 514). In some embodiments text originated from an automatic speech recognition process as is known in the art (not shown). In some embodiments, thought-text parser 609, may modify word contents of the plurality of text by, for example, removing stop words, stemming words, tokenizing words, determine frequency of words, etc. Topic generator 613 may generate a plurality of topic vectors in a topic table, each topic vector associated to a thought object 510 of the plurality of thought objects 510. A topic vector is used to identify topics associated with a thought calculated based on techniques described herein (referring to FIG. 12). Topic vectors may be used to calculate a diversity score whereby diversity is defined as a Euclidean distance between thought objects previously rated by a particular participant device 621 and thought objects not yet rated by the particular participant device 621 (that is, one or more thought objects 510 available to be selected for distribution to the particular participant device 621).

Response database 610 may store received response information from the plurality of devices 620. In some embodiments, response database 610 holds just priority value responses while in others, priority value responses are held in priority value objects 559. Object database 611 may provide database storage for objects 500 and 600 both pre-configured and objects with assigned data fields. Configuration database 612 provides storage for systems configuration components, for example, at least, configuration for devices 620, system components 600, and the like. It can be appreciated by one with ordinary skill in the art that the above referenced databases provide an exemplary set of databases required to implement system 600A components and data necessary to execute the disclosed methods.

Devices 620 comprise participant devices 621 and leader devices 622. A leader device 622 may configure a project object 539 associated to one or more question objects 546 to solicit a plurality of thought objects 510 based on an arrangement of information in the form of an open-ended free-flow question for the purpose of receiving priority value responses received, by project controller 602, from at least a portion of plurality of participant devices 620 (whereby the at least portion of devices may be hereinafter referred to as participant devices 620) and stored in a plurality of priority value objects 559 for analysis by system 600A. In a preferred embodiment, leader devices 622 may initiate and manage a project (as defined in a project object 539 that comprises one or more question objects 546 via a process defined in process object 569) and at least a portion of participant devices 621 (i.e. those that have responded, comprise participant objects 620. In some embodiments, leader devices 622 may be considered participant devices and may act as both a leader device 622 and a participant device 621.

In some embodiments during operation, word embeddings for the thought objects may be computed by non-transformer based embedding models 655. Non-transformer models 655 may be used for their simplicity, interpretability, and computational efficiency. Examples of non-transformer based embedding models 655 may include but are not limited to GloVe, Word2Vec, and FastText.

Embeddings can also be generated from the encoder part of large language models (LLMs), such as those based on the Transformer architecture, referred to here as transformer-based embeddings. The encoder processes input text by capturing contextual information and relationships between words, producing high-dimensional vector representations, or embeddings, for each token. These embeddings encapsulate semantic meaning and can be utilized for various downstream tasks, such as text classification, similarity measurement, and information retrieval. By leveraging the encoder's ability to understand and represent complex language patterns, embeddings generated from LLMs are highly informative and effective for similarity measurement.

In an embodiment, the embedding per thought may be calculated by combining the word embeddings using a Siamese network 657. A Siamese network 657 is a type of neural network architecture that is particularly useful for similarity tasks. Rather than classifying inputs, Siamese networks learn to differentiate between inputs. When used for combining embedding inputs, whether generated by transformer-based models or non-transformer-based models, Siamese networks can employ various techniques, including but not limited to Simple Averaging or Weighted Averaging, RNN, LSTM, GRU, attention mechanisms, and pooling.

Embeddings per thought can be generated using methods such as Latent Dirichlet Allocation (LDA), Latent Semantic Analysis (LSA), or Non-negative Matrix Factorization (NMF). These methods focus on extracting topic distributions and latent semantic structures from the text, providing meaningful vector representations that capture the underlying themes and relationships within the data. These techniques are particularly useful for tasks involving topic modeling and semantic analysis.

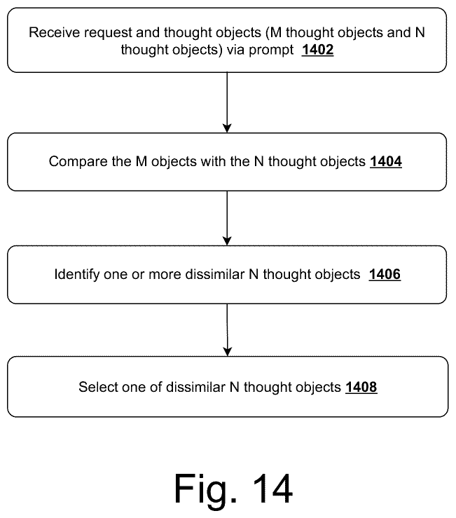

In an embodiment, a large language model (LLM) 650 may be used for selection of diverse thought object. LLM may be a foundation model that utilizes deep learning in NLP and natural language generation (NLG) tasks. A trained transformer architecture is referred to as a Large Language Model (LLM). More details related to the LLM 650 may be described in FIGS. 6B-6C and FIG. 14.

FIG. 6B is an example block diagram of an encoder transformer model 630 and decoder transformer model 640, in accordance with an embodiment of the invention. In an embodiment, LLM 650 may be an encoder transformer model 630 and/or decoder transformer model 640. Further in some cases, and encoder-decoder transformer model may be used object selection. Neural transformers used for performing natural language processing (NLP) may be referred to as Foundation models or Language models. NLP tasks that can be performed by neural transformers may include but are not limited to, language translation, text summarization, speech synthesis, image processing, and question-answering systems. Transformer architecture depicted in FIG. 6B can be combined with different types of neural networks such as CNN, RNN, LSTM, transformers, etc. to enhance its capabilities and address complex problems.

In an embodiment, encoder transformer model 630 includes an input processor 616A for tokenization of an input sequence (herein also referred to as input data) whereby the input sequence may be split into tokens (words or sub-words) and embedded into a dense vector representation. Tokenization is cutting input data into parts (symbols) that can be mapped (embedded) into a vector space. In some embodiments, special tokens may be added to mark the beginning and end of a sequence. In an embodiment, input processor 616A includes a tokenizer with a large dataset of tokens, including all the words, punctuation signs, etc. The tokenization step takes every word, prefix, suffix, and punctuation sign, and sends them to a known token from the library.

Embedding layer 621A converts discrete tokens (such as words, sub word, or characters) into continuous vector representations, (herein also referred to as embeddings), In some embodiment, embedding layer 621A may use pre-trained word embeddings (e.g., Word2Vec, GloVe) or subword embeddings (e.g., Byte Pair Encoding or WordPiece), however, advantageously, embedding layer 621A may also handle various levels of granularity for tokens, including words, sub words, or even characters. Accordingly, embedding layer 621A may receive input as a sequence of tokens. Each token may be represented as an integer or a one-hot encoded vector, indicating its position in a predefined vocabulary. Embedding layer 621A may map each discrete token to a continuous vector in a high-dimensional space. These continuous vector embeddings may capture the semantic meaning and context of the tokens. For instance, tokens with similar meanings should have embeddings that are close in vector space.

Embeddings may be learnable parameters of a model whereby, during training, the model may learn to adjust embeddings to minimize a loss function by making them informative about the input data. This means that the embeddings may be updated via backpropagation during the training process. It should be noted that embeddings, from embedding layer 621A, are high-dimensional vectors, often with hundreds of dimensions. This high dimensionality enables the model to capture fine-grained relationships and nuances between tokens in the input data. It also allows the model to learn complex patterns and hierarchies within the data. In some embodiments, the same embeddings may be shared between input and output layers to reduce the parameter count of the model and enhance efficiency. Accordingly, sharing embeddings may help maintain consistency between input and output representations.

Positional encoding 649A may provide information about the order of words whereby positional encoding is added to the word embeddings to provide information about the token's position in a sequence to provide a model with information about the position of each token in the input sequence for capturing sequential dependencies in data comprised within the input sequence. Accordingly, the model may process all tokens in the input sequence in parallel. In a preferred embodiment, positional encoding 649A may treat each token independently and inject information about the position of each token. In some embodiments, positional encoding 649 may learn encoding during training and such encoding may be added to the token embeddings in a way that it varies across dimensions and positions. In some embodiments, positional encoding 649A may use sinusoidal encoding by using a combination of sine and cosine functions with different frequencies and phases to ensure that a positional encoding is unique for each position while capturing a relative position of tokens effectively. According to the embodiment, using sinusoidal functions, positional encoding 649A may introduce a sense of periodicity to the embeddings, allowing the model to distinguish tokens at different positions. A choice of frequencies may ensure that tokens with different positions have distinct positional encodings. This may help the model learn dependencies that are based on the order of tokens. Further according to the embodiment, during each forward pass of the model, positional encoding 649A may modify each token's embedding based on its position in the sequence, making it unique and informative with respect to its position. Positional encoding 649A may function in conjunction with self-attention mechanisms within the architecture to attend to different parts of the input sequence based on the content of the tokens and the positional information. This allows the model to give appropriate attention to contextually relevant tokens. Advantageously, positional encoding 649A provides a learnable component whereby during training, the model learns appropriate encoding patterns that may best capture the sequential dependencies in the training data. This means that the model can adapt to sequences of different lengths and patterns. Positional encoding 649 may provide the model with the necessary information to understand the order and relationships between tokens in the input sequence for processing natural language tasks and other sequence-based tasks in deep learning. Input processor 616A works with token embeddings and positional encodings (from positional encoding 649A) combined with parallel processing and self-attention mechanisms for efficient and effective machine translation, text generation, sentiment analysis, and the like.

In an embodiment, each layer of encoder transformer model 630 comprises a feed-forward component and an attention component. In an embodiment, the first layer includes attention 623 and feed-forward 624. The second layer includes attention 625 and feed-forward 626.

Attention component may be used for deciding which parts of the input sequence are important for each token/sub-token, especially when decoding long sequences since the encoder is limited to encoding a fixed-size vector. Attention mechanisms gather information about the relevant context of a given token/sub-token and then encode that context into a vector that represents the token/sub-token. It is used to identity the relationships between tokens in the long sequence while ignoring other sub tokens that do not have much bearing on a given prediction.

In an embodiment, feed-forward is a feed-forward neural network. After the self-attention mechanism, the encoded representations pass through a feed-forward neural network (FFNN) in each layer. This FFNN consists of two linear transformations separated by a non-linear activation function, such as the Rectified Linear Unit (ReLU). The FFNN helps capture complex patterns and relationships in the encoded representations, enabling the model to learn higher-level features.

In an embodiment, the attention component utilized in encoder transformer model 630 layers may be a self-attention mechanism that allows a token to weigh the importance of every other token in the sequence when encoding information. However, a single self-attention mechanism may not be sufficient to capture various types of dependencies within the data, therefore, a multi-head self-attention mechanism addresses this limitation. Accordingly, the multi-head self-attention mechanism applies the self-attention operation multiple times in parallel, with each head (that is, a separate and parallel processing pathway that independently attends to different aspects or patterns within the input sequence) having its own set of learnable parameters (for example, for query, key, and value projections). Each head can focus on different aspects of the input, enabling the model to capture diverse patterns and relationships.

Each encoder layer comprises a feed-forward component whereby after attention, the information passes through a neural network that may perform a transformation to introduce non-linearity into the model as modeled data relationships disclosed herein are non-linear. This transformation allows the model to learn relevant features or representations of the input data. Further, by iteratively stacking multiple encoder layers, transformer architecture can effectively capture complex patterns and dependencies in the input sequence, leading to state-of-the-art performance in various natural language processing tasks such as machine translation, text generation, and sentiment analysis.

Output layer 635 comprises a liner layer and a SoftMax layer. The linear layer is a fully-connected neural network that projects the raw scores output by the last layer of the neural network into a logit vector. The SoftMax layer applies the softmax function to the logits vector to compute a vector that represents the probability distribution of a list of potential outcomes. In some embodiments, attention scores may be calculated and scaled and then passed through a softmax function to obtain the attention weights. These weights may determine how much each token may contribute to the output of the self-attention operation. Tokens that are more relevant to the current token may receive higher attention weights.

In an embodiment, decoder transformer model 640 includes a positional encoding 649B, an embedding layer 621B, and a processor 616B performs the same function as positional encoding 649A, embedding layer 621A, and processor 616A described for encoder transformer model 630.

In an embodiment, each layer of decoder transformer model 640 comprises a feed-forward component and an attention component. In an embodiment, the first layer includes attention 627 and feed-forward 628. The second layer includes attention 629 and feed-forward 631. The third layer includes attention 632 and feed-forward 633.

In an embodiment, attention component of decoder layers includes a masked self-attention component. The masked self-attention component allows the neural network to identify certain features or inputs. The inputs to the decoder block are added with the positional embeddings 649B. Decoder layers may be configured to predict each token/subtoken in the target language one-by-one at each time step conditioned on all previously-generated target tokens/subtokens. The masked self-attention component in each layer masks the output embeddings from future time steps. The feed-forward neural network processes each output embedding separately.

Output layer 634 includes a linear layer and a SoftMax layer. Blocks of decoder transformer model 640 may be capped off with a linear layer that acts as a classifier, and a softmax to get the word probabilities Linear layer projects the vector produced by the stack of decoders into a logits vector, and the softmax layer then turns the scores of the logits vector into probabilities for each token in the vocabulary which are positive and normalized.

The transformer architectures described above can be used as a model for performing NLP-related functions. A trained transformer architecture is referred to as a Large Language Model (LLM). LLM may be a foundation model that utilizes deep learning in NLP and natural language generation (NLG) tasks. To help them predict the complexity and linkages of language, language models are pre-trained on a vast amount of data. LLM may be trained using a large dataset of text paired with appropriate labels (e.g., responses in a conversational dataset). Training involves minimizing a loss function (e.g., cross-entropy) between the predicted output and the actual target sequence. Accordingly, the model learns patterns and relationships within the data to enable the model to make accurate predictions, and classifications, or generate desired outputs when presented with new, unseen data. Training begins with the collection of a dataset that consists of input data (features) and corresponding target labels or ground truth values. The dataset may be representative of the problem the methods disclosed herein is intended to solve. The large language model or language model structure, architecture, and parameters may be defined to include neural networks, decision trees, support vector machines, and more, depending on the nature of the task. Training may include the use of a loss function, also known as a cost or objective function, is chosen to measure the difference between the model's predictions and the true labels in the training data. The goal is to minimize this loss, as it quantifies the model's performance. Training may utilize an optimization algorithm to adjust the model's parameters (e.g., weights and biases) during training in a way that minimizes the loss. Optimization algorithms may include stochastic gradient descent (SGD), Adam, and RMSprop. During training, data may be fed through the model in a forward pass to make predictions, a loss is then calculated, and gradients of the loss with respect to the model parameters may be computed in a backward pass. Parameters may be updated using the gradients and the chosen optimization algorithm. The learning rate, which determines the step size of parameter updates, may be adjusted. Training may be performed iteratively for multiple epochs (complete passes through the training data) in order to improve the model's performance with each epoch, gradually reducing the loss. During training, a separate validation dataset may be used to monitor the model's performance on data it hasn't seen before. This helps detect overfitting and guides hyperparameter tuning. After training is complete, the model is evaluated on a test dataset that it has never seen. This provides a final assessment of the model's generalization performance. Based on NLP related task, a transformed model architecture is selected.

In some embodiments, an encoder-decoder neural transformer model is used which includes encoder transformer model 630 and decoder transformer 640. Encoder transformer model 630 processes the input data and transforms it into a different representation, which is subsequently decoded by the decoder transformer 640 to produce the desired output. The output of the top encoder layer is a set of attention vectors K and V which is used by the multi-head attention layer of the decoder neural transformer model 640. An LLM with an encoder-decoder architecture is used for tasks where an input sequence needs to be transformed into an output sequence, such as machine translation or summarization. The encoder processes the input sequence and compresses the information into a “context vector,” and the decoder then uses this context vector to generate the output sequence.

In an LLM with an encoder transformer model 630 attention is trained on a large unsupervised training dataset of source code and natural language source code summaries. The encoder transformer model 630 may be then fine-tuned by a fine-tuning component with a particular supervised training dataset for a particular downstream task to produce a corresponding model.

An LLM with encoder transformer model 630 is suited for classification tasks due to the type of attention used in the encoder. Encoder transformer model 630 architecture is often employed in tasks like text classification, sentiment analysis, embedding generation, text generation, language understanding, document classification, and question answering. BERT™ (Bidirectional Encoder Representations from Transformers) is a widely used Encoder-only model. It has been pre-trained on a large corpus of text and can be fine-tuned for specific NLP tasks.

An LLM with a decoder transformer model 640 is an auto-regressive model that produces an output one element at a time based on the outputs of previous time steps. Code completion is best suited for a decoder transformer model 640 since it is an auto-regressive task that predicts an ordered sequence of tokens where the order depends on the preceding tokens in the sequence. Decoder transformer model 640 uses a masked self-head attention which is best suited for auto-regressive tasks since it is explicitly trained to generate auto-regressively. This type of neural transformer model is best suited for text generation, summarization, text completion, language modeling, text correction, and dialogue systems.

Generating text that is both coherent and contextually consistent is a significant challenge in many NLP tasks, such as text generation, machine translation, and content summarization. Decoder-only transformer architectures have been designed to address this problem. GPT (Generative Pre-trained Transformer) models such as GPT-2 and GPT-3 utilize a Decoder-only structure to generate coherent and contextually relevant text.

In decoder transformer model 640, the multi-head self-attention mechanism in the decoder layers is similar to the one in the encoder layers, but it is masked to prevent the model from attending to future positions, ensuring that the predictions for position “i” can depend only on the known outputs at positions less than “I.” This masking happening internally in the decoder's multi-head self-attention mechanism) is essential to maintain the autoregressive property of the transformer model during training and inference. The autoregressive property ensures that the model generates output tokens one at a time and uses previously generated tokens as context for generating the next word token. Decoder transformer model 640 may often employed for text generation, and larger ones display strong zero-shot inference abilities, performing well across a range of tasks. Zero-shot learning (ZSL) is a machine learning scenario in which an AI model is trained to recognize and categorize objects or concepts without having seen any examples of those categories or concepts beforehand. They can perform tasks with limited or no task-specific training data by leveraging the knowledge acquired during pre-training. This is particularly useful in scenarios where labeled data is scarce or when adapting. Further, decoder-based models, particularly those with a large number of layers and attention heads, can capture long-range dependencies in the generated text. They can maintain coherence and consistency over longer sequences, which is important for tasks that require generating longer passages of text. Notable examples of decoder-based autoregressive models are GPT (Generative Pre-trained Transformer), Megatron-LM Transformer-XL, CTRL (Conditional Transformer Language Model).

In some embodiments, decoder transformer model 640 may offer the ability to control the generated text by conditioning on specific prompts, attributes, or styles. By providing appropriate prompts or control codes, the model may be guided to generate text with desired properties, such as sentiment, topic, or writing style. This controllability is valuable for applications like content creation, personalization, and dialogue systems.

Referring now to FIG. 6C, a block diagram for the generation of a fine-tuned LLM for tasks is described. A base LLM 642 is a pre-trained language model. Pre-trained language models may be released in various sizes, ranging from small to large, with the base version being one of the smaller configurations. Generally, base LLMs are trained on large volumes of internet data/text 641 to understand and predict linguistic patterns. Examples of base LLM 642 may include GPT-3, GPT-4, or BERT. These models vary in size; the smaller configurations, although less complex, are quicker to train and deploy than their larger counterparts.

Nevertheless, they still deliver robust performance across diverse natural language processing tasks. Base LLMs have fewer parameters compared to their larger counterparts, making them more lightweight and faster to train and deploy. While they may not capture as much complexity and nuance as larger models, they still offer strong performance across a variety of natural language processing tasks. Additionally, base LLMs are often used as a starting point for fine-tuning specific downstream tasks or as a component in larger, more specialized models. To use an existing (base) LLM for specific tasks or technology areas, base LLM 642 may be tuned as per the target technology area/use case/domain. During fine-tuning, parameters of base LLM 642 are adjusted based on the new dataset, helping it better understand and generate content relevant to the specific task. This process retains the general language knowledge gained during pre-training while tailoring the model to the nuances of the target domain.

A fine-tuned LLM 644 is generated by fine-tuning a base LLM 642 and training it on a specific and smaller dataset for a specific task using dataset 643. In an embodiment, dataset 643 is a training dataset that provides instructions. Once the instruction data set is ready, as with standard supervised learning, the data set may be divided into training validation and test splits. During fine-tuning, prompts from your training data set are selected and passed to base LLM 642, which then generates completions.

During the fine-tuning phase, when the model is exposed to a newly labeled dataset 643 specific to the target task, it calculates the error or difference between its predictions and the actual labels. The model then uses this error to adjust its weights, typically via an optimization algorithm like gradient descent. The magnitude and direction of weight adjustments depend on the gradients, which indicate how much each weight contributed to the error. Weights that are more responsible for the error are adjusted more, while those less responsible are adjusted less. Over multiple iterations (or epochs) of dataset 643, the model continues to adjust its weights, honing in on a configuration that minimizes the error for the specific task. The aim is to adapt the previously learned general knowledge to the nuances and specific patterns present in the new dataset, thereby making the model more specialized and effective for the target task. During this process, the model is updated with the labeled data. It changes based on the difference between its guesses and the actual answers. This helps the model learn details found in the labeled data. By doing this, the model improves at the task for which it's fine-tuned.

In an embodiment, base LLM 642 may be fine-tuned using a pre-defined prompt with rules, instructions, context, and dataset to perform tasks related to object theming. In one embodiment, a predefined prompt may include instructions that can guide a generic LLM to perform tasks related to supervised object theming.

### Detailed Description of Exemplary Embodiments

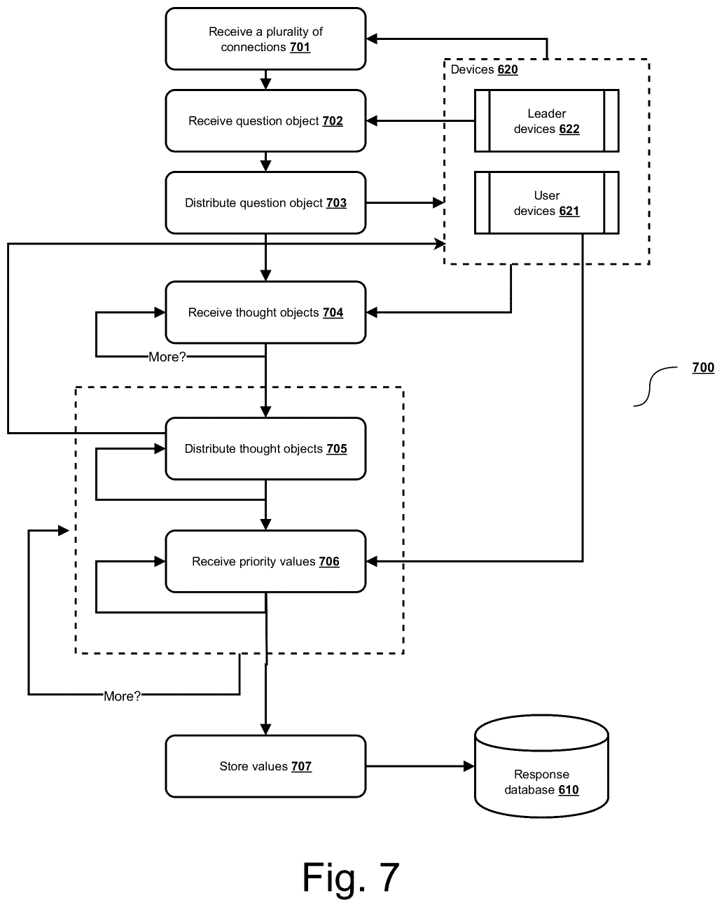

FIG. 7 is a flow diagram illustrating a method for conducting a process to solicit thought objects and priority value responses from a plurality of devices, according to a preferred embodiment of the invention. According to the embodiment, in a first step 701, a plurality of connections from a plurality of devices 620 are received via network 310 at device interface 708 to enable communication between system 600A and connected devices 620 and, in some embodiment, remote response database 630. In a next step 702, question object 546 is received, by project controller 602, from a first leader device 622 via device interface 601 to begin a process to solicit thought objects and priority value responses. It should be appreciated that question object 546 may be associated to a previously configured project object 539 and belong to a tenant object 590. Question object 546 may comprise an arrangement of information comprising open-ended free-form text arranged in a manner whereby responses from at least a portion of participant devices 621 may be solicited (for example, arranged in the form of a question), the expected responses comprising a plurality of thought objects 510. In a next step 703, project controller 602 may then distribute question object 546 to at least a portion of devices 620 via device interface on network 310. In a next step 704, a plurality of thought objects 510 may be received by at least a portion of devices 620, the plurality of thought objects 510 each comprising, at least, an arrangement information (for example, within thought_detail 514), the arrangement of information comprising open-ended free-form text arranged in a manner whereby responses from at least a portion of participant devices 621 may be solicited, the expected responses comprising a plurality of priority value objects 559, each priority value object 559 comprising priority value 565 comprising a priority value associated to a thought object (for example thought object 562 may associate priority value 565 to a corresponding thought object 510). Further in step 704, topic generator 613 generates a plurality of topic vectors in a topic table, each topic vector associated to a thought object 510 of the plurality of thought objects 510 (referring to FIG. 12) In a next step 705, the plurality of thought objects 510 may be distributed, by project controller 602, to at least a portion of user devices 620 via device interface over network 310, utilizing thought selection algorithms described herein (referring to FIG. 8) to one or more devices 620. In a next step 706, project controller 602 may receive a plurality of priority value objects 559 (herein referred to as priority value responses) from at least a portion of devices 620, the plurality of priority value responses each associated to a corresponding thought object 510 (as described previously), the at least portion of responding devices 620 herein referred to as participant devices 620, each priority value response associated to a corresponding thought object 510 and a corresponding participant device of the participant devices 620. In a next step 707, project controller 602 may store the plurality of thought objects 510 and associated priority value responses in response database 610 (in some embodiments, project controller 602 may store the plurality of thought objects 510 and associated priority value responses in remote response database 648 via network 310).

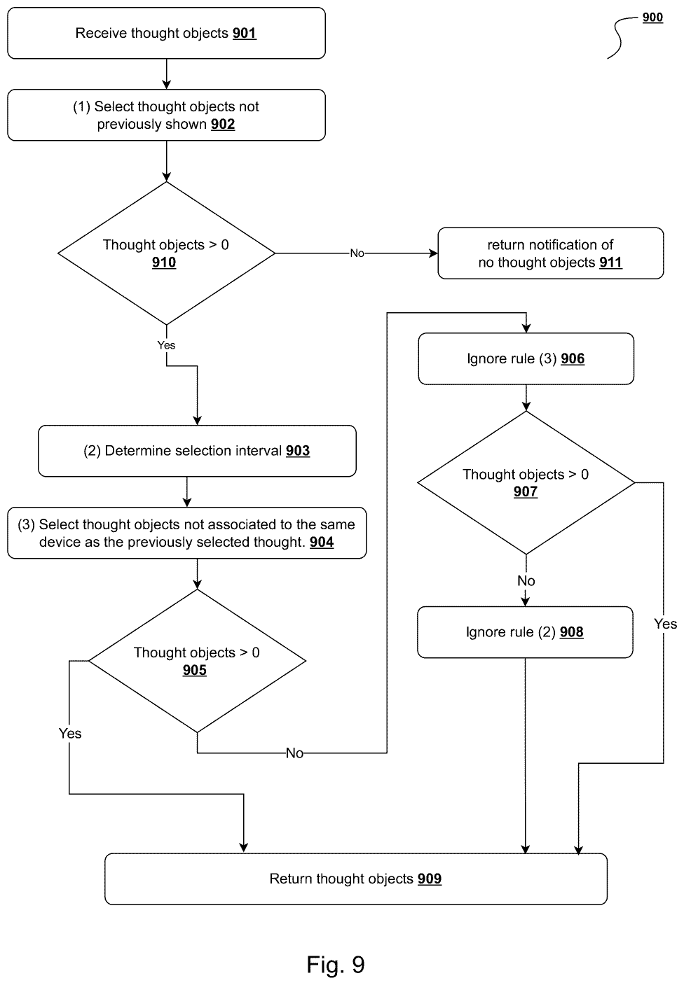

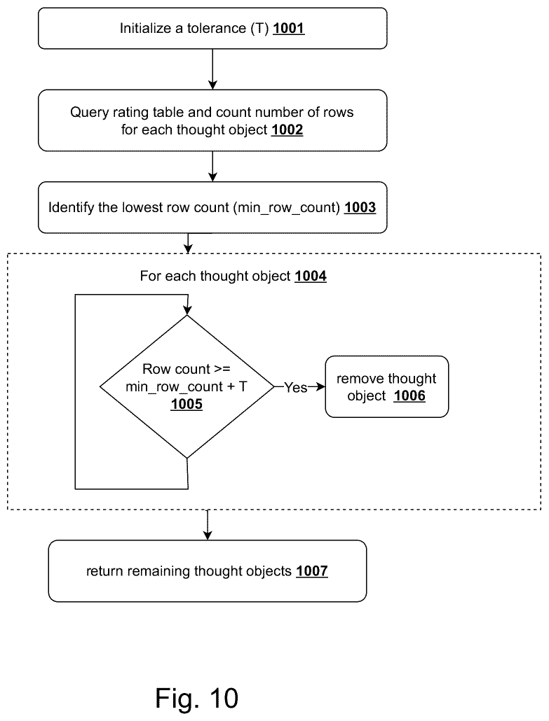

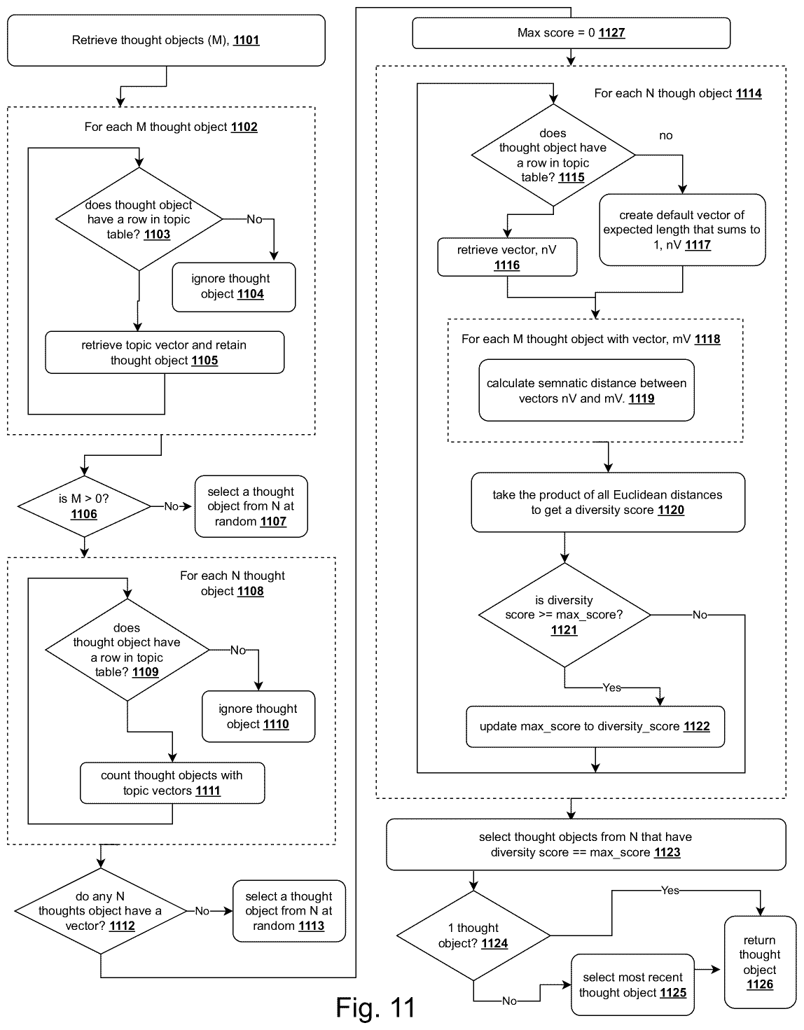

FIG. 8 is a flow diagram illustrating a method for thought object selection based on a plurality of filtering and selection methods, according to a preferred embodiment of the invention. According to the embodiment, method 800 starts in a first step 801, where a request is received, from a first participant device 621, to rate a thought object 510. In a next step 802, project controller 602 checks a quantity of shared thought objects 510. In a next step 803, all thought objects 510 are retrieved. In a next step 804, at least a portion of thought objects 510 are filtered, by custom selection method (referring to FIG. 9). Once filtered, zero or more filtered thought objects 510 (herein referred to as filtered thought objects 510 N1) are returned. If no filtered thought objects 510 are returned (that is, N1=0), in step 805, then no thought objects 510 are available for selection. Otherwise, in a next step 806, if more than one thought object 510 are returned (that is N1>1), then the returned filtered thought objects 510 (from step 804), are further filtered, in a next step 808, by random selection (herein referred to as N2 which are at least a portion of filtered thought objects 510. In a preferred embodiment five filtered thought objects 510 may be selected at random from N1. In other embodiments, any pre-configured number of filtered thought objects 510 may be selected at random from N1. In a next step 809, filtered thought objects 510 N2 are further filtered by least seen (referring to FIG. 10), that is, a selection of one or more thought objects 510 by those that were delivered to participant devices 621 the least number of times as compared to other thought objects 510, the returned filtered thought objects 510 herein referred to N3 representing at least a portion of thought objects 510 from N1 or N2. In a next step 810, if N3 filtered thought objects 510 is greater than one, then a thought object 510 is selected by topic (i.e. most diverse) in step 811 (referring to FIG. 11). In a next step 812, final filtered thought 510 is shown to a first user device 620.

FIG. 9 is a flow diagram illustrating a method for filtering a plurality of thought object based on a plurality of custom selection rules, according to a preferred embodiment of the invention. According to the embodiment, a plurality of programming instructions stored in memory 240 when executed by one or more processors 210 cause the one or more processors 210 to perform method 900 for custom selection of one or more filtered thought objects 510 begins in a first step 901 whereby thought objects are received by object selector 607 (for example from object database 611). In a next step 902, the plurality of thought objects 510 may be selected, in a first filtering step (1), by object selector 607, whereby the selected filtered thought objects 510 are at least a portion of thought objects 510 not previously shown (that is delivered) to an output device 260 associated to a first participant device 621. In a next step 910, if no thought objects 510 remain, then a notification that no thought objects 510 are available is returned to the participant device 621, in step 911. Otherwise, if there are thought objects 510 remaining from filtering step (1), the process continues. In a next step 903, if the first participant device 621 selects a thought object 510 at a predefined interval (In a preferred embodiment, the predefined interval may be, the 5^{th}, 10^{th}, 15^{th}, etc. thought object 510, i.e. an interval divisible by 5; however, any interval or pattern may be used), then object selector 607 considers only thought objects 510, in a second filtering step (2), shared by the first participant device 621, that is, thought objects 510 associated to the first participant device 621. In a next step 904, thought selector may consider only thought objects 510, in a third filtering step (3), that are not associated to another participant device 621, to which another thought object 510, selected by the thought selector in response to a previous request from first participant device 621, is associated, that is, thought objects 510 not shared by the same user as a thought object 510 previously selected by object selector 607 for the first participant device 621. In a next step 905, if there are one or more filtered thought objects 510, then the filtered thought objects 510 are returned by object selector 607 in step 909; otherwise, if no filtered thought objects 510 result, then the third filtering step is ignored and only filtered thought objects 510, filtered by a first filtering step (1) and a second filtering step (2) are considered in step 907. Further in step 907, if no thought objects 510 result from a first filtering step (1) and second filtering step (2), then the second filtering step (2) is ignored, by object selector 607, and filtered thought objects 510 from a first filtering step (1) only are returned, in step 909, by object selector 607.

FIG. 10 is a flow diagram illustrating a method for filtering a plurality of thought objects by computing one or more thought objects that were least displayed to an output module of a participant device, according to a preferred embodiment of the invention. According to the embodiment, a plurality of programming instructions stored in memory 240 and when executed by at least one processor 210 cause the at least one processor 210 to perform a method for filtering and selecting one or more thought objects 510 that were least displayed on an output device 260 of an associated participant device 621 starting with a first step 1001, object selector 607 initializes a tolerance (T), for example to a zero value. In a next step 1002, a rating table, from object database 611, may be queried to determine a count for a number of rows associated to each thought object 510, representing the number of times the thought object 510 has been on an output device 260 of an associated participant device 621. In a next step 1003, Identify, by object selector 607, the lowest row count (min_row_count) for all thought objects 510. In a next plurality of steps 1004, object selector 607 identifies one or more thought objects 510 by selecting thought objects associated to ratings tables with a row count that may be less than or equal to the lowest row count (referring to step 1003) plus a tolerance by: iteratively analyzing each rating table associated to each thought object 510, in step 1005, whereby if a row count is greater than the min_row_count plus the tolerance, the thought object 510 is removed from consideration in step 1006. Once all thought objects have been analyzed, the remaining thought objects 510 are returned in step 1007.

FIG. 11 is a flow diagram illustrating a method for filtering a plurality of thoughts based on a topic calculation, according to a preferred embodiment of the invention. According to the embodiment, a plurality of programming instructions stored in memory 240 and when executed by at least one processor 210 cause the at least one processor 210 to perform a method for filtering a plurality of thoughts based on a topic calculation beginning in a first step 1101, object selector 607 retrieves the most recent M thought objects 510 previously distributed to the associated participant device 621, where M is 1 in a preferred embodiment (however, in some embodiments, any number may be used for M). That is, M thought objects 510 representing thoughts previously displayed to the associated participant device 621.

In a plurality of steps 1102, for each M thought object 510, object selector 607 may perform the following steps: In step 1103, each M thought object 510 may be checked to see if it has a row in a topic table (as previously calculated referring to FIG. 12) wherein the topic table comprising a plurality of vectors that numerically represent topics associated to thought objects 510. If the M thought object 510 does not have a row in the topic table, in a next step 1104, the thought object 510 is ignored, that is the thought object 510 is not considered in a resulting the filtered set; otherwise, if there is an associated row in a topic table, the topic vector (i.e. the row) associated to the thought is retained, in step 1105, and the process continues at step 1103 until all M thought objects 510 are analyzed.

Once all topic vectors are analyzed for all M thought objects 510 the number of remaining thoughts, from the plurality of steps 1102, is analyzed in step 1106. If there are no remaining M thought objects 510 then a thought object 510 is selected at random from N3 (referring to FIG. 8) 1107 to be distributed to the associated participant device 621; otherwise, a plurality of steps 1108 will be processed on the remaining N3 thought objects 510 in order to select the most diverse thought, relative to the previous M thoughts, to select for distribution to the associated participant device 621.

In a plurality of steps 1108, For each N3 thought object, object selector 607 may perform the following steps: in step 1109, a check to determine if the thought object 510 has a row in the topic table is performed. If it does not, in a next step 1110, the thought object 510 is ignored; otherwise, if there is an associated row in a topic table, a count of thought objects 510 with topic vectors is calculated in step 1111.

Once all topic vectors are analyzed for all N3 thought objects 510, the count of thought objects with topic vectors, from the plurality of steps 1108, is analyzed in step 1112. If the count is zero then a thought object 510 is selected at random from N3 in step 1113; otherwise, steps 1114 is initialized. In step 1114, a max score is initialized (for example to zero) and a plurality of steps 1114 may be processed on the remaining N3 thought objects 510 beginning with step 1115, whereby object selector 607 determines if a first remaining thought object 510 has an associated row in a topic table. If so, the vector (i.e. row nV) is retrieved in step 1116; otherwise, object selector 607 creates, in step 1117, a default vector (nV) of an expected length (that is the length of current vectors for other vectors; it should be noted that an expected length would have been known from step 1112 since a check was performed for any N thought objects 510 having a topic vector), the values of the created vector summing to 1. In a next step 1118, for each remaining M thought with a vector in the topic table (mV), a semantic between mV and nV is calculated, in step 1119, by topic calculator 608. In an embodiment, semantic distance may be cosine distance or Euclidean distance between the vectors. In a next step 1120, a product of all Euclidean distances is calculated, by topic calculator 608, to get a diversity score. In a next step 1121, the diversity score is compared to the max_score, by topic calculator 608. If diversity score is less than the max_score, the method returns to step 1115 to process a next N thought objects 510; otherwise, the max_score is updated to equal the calculated diversity score, in step 1122, and the method returns to step 1115 to process a next N thought objects 510.

Once all N3 thought objects 510 are processed, in a next step 1123, all thought objects from N thought objects 510 that each have diversity score equal to max_score is selected by object selector 607. If only one thought object remains in step 1124, the one thought object 510 is returned as the filtered thought 510; otherwise, in step 1125, a most recently seen thought object 510 is selected and returned as the filtered thought object in step 1126.

FIG. 12 is a flow diagram illustrating a method for calculating a topic vector, according to a preferred embodiment of the invention. According to the embodiment, a plurality of programming instructions stored in memory 240 and executed by one or more processors 210 cause the processor to perform a method for calculating a topic vector whereby a vocabulary may be created in a plurality of thought objects parsed by thought-text parser 609 (for example, based on thought_summary 513 and thought_detail 514 associated to a thought object 510) of all thought objects 510 available in an exchange by machine learning and natural language processes disclosed herein to create a statistical model to discover “topics” that occur in one or more thought objects 510 by using text-mining techniques known in the art to discover structures in a text body.

Accordingly, in a first step 1201, a shared thought object 510 is received, by the project controller 602, from a first participant device 621 of a plurality of participant devices 621. In a next step 1202, at least a quantity N of thought objects that need topic vectors calculated is determined, by topic calculator 608, whereby N may be a pre-configured or a dynamically calculated number. If no thought objects need a calculation of a topic vector, in a next step 1219, no calculation is performed. If at least a quantity N of thought objects need topic vectors, in step 1203, all thought objects in an exchange are retrieved. In a next plurality of steps 1204, for each thought object 510 the following steps are performed by topic calculator 608: In step 1207, thought object 510 is converted to lower case. In a next step 1208, a tokenizer library (for example, Natural Language Toolkit (NLTK)) may be used to tokenize thought object 510, that is, assign a token to each word. In a next step 1209, thought-text parser 609 may remove stop words from thought object 510 whereby the stop words may be pre-configured in a list. Accordingly, the tokens associated to the stop list words are removed, by thought-text parser 609, from thought object 510. In a next step 1210, thought-text parser 609 may stem the remaining tokens (for example, using NLTK stemming library), by shortening words to their root value by a process of reducing inflected (or sometimes derived) words to their word stem, base or root form using a stemming program, stemming algorithm, or other stemmer techniques known in the art.

In a next step 1211, an array of all stemmed-tokens from all thought objects 510 may be created by thought-text parser 609. In a next step 1212, a list of all unique stemmed-tokens may be created by thought-text parser 609. In a next plurality of steps 1213, for each thought object 510 the following steps are performed by topic calculator 608: in step 1214, an empty vector the length of all unique stemmed-tokens may be created; in a next step 1215, a frequency of each stemmed-token in thought object 510 is computed and added to the vector.

In a next step 1216, the number of topics for a latent Dirichlet allocation (LDA) model may be determined by document generator 609. In an exemplary embodiment, a number of topics N may be found using any integer value based on the number of thought objects 510. For example, N may be: 10, if fewer than 21 thought objects 510; 20, if fewer than 31 thought objects 510; 30, if fewer than 41 thought objects 510; 40, if fewer than 51 thought objects 510; 50, if more than 50 thought objects 510. In a next step 1217, an LDA model is generated using stemmed-token counts for each thought object 510. In a next step 1218, a plurality of topic vectors is retrieved, by thought-text parser 609, from the LDA model for each thought object 510 and saved to object database 611 as a thought object topic table.

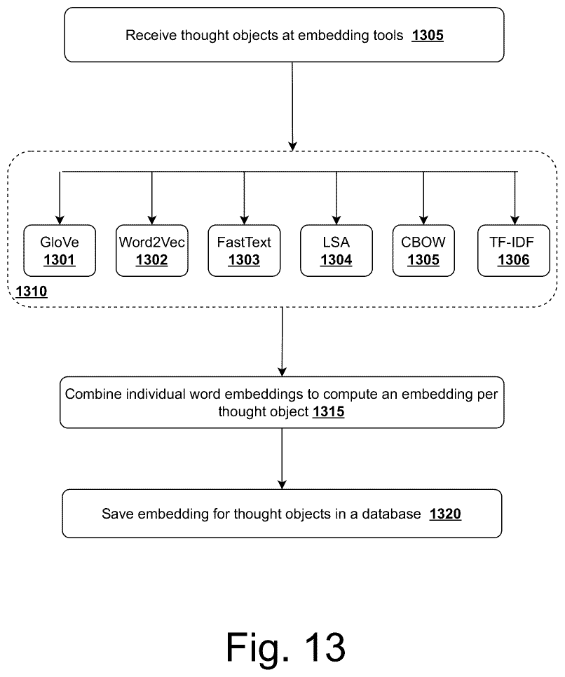

FIG. 13 is a flow diagram illustrating a method for determining an embeddings for each thought object, according to a preferred embodiment of the invention.

At step 1305, thought objects are received by one or more non-transformer-based embedding models 655. In an embodiment, thought objects may include data such as text present in a review, survey data, emails, Instant messaging (IM), discussion forums, or text from any other communication environment. In an embodiment, a thought object includes a qualitative response. Qualitive response may be an open-ended, comment-style response, where the participant has the freedom to textualize associated ideas and is not constrained by pre-determined answers. Accordingly, eliciting qualitative responses may have substantial benefits over quantitative responses in that qualitative responses can provide more detailed information on participant interests, consisting of areas of alignment, sentiment, or topics, to name a few.

In addition to thought objects originating from communication exchanges, the present invention also encompasses thought objects corresponding to survey responses provided by users. Surveys are a structured method of gathering information from a targeted group of respondents, often used to gain insights into opinions, preferences, experiences, or behaviors. In the context of the present invention, survey responses can serve as a valuable source of thought objects, offering a diverse range of perspectives and ideas on specific topics of interest.

When applying the concept of thought objects to survey responses, each response to an open-ended (or structured), survey question can be considered a thought object. These responses capture the respondents' qualitative feedback, opinions, and insights in their own words. By treating survey responses as thought objects, the same techniques and processes described herein may be applied to analyze, filter, and select diverse and representative responses from a larger pool of survey data.

For example, consider a customer satisfaction survey that includes an open-ended question asking respondents to describe their experience with a particular product or service. Each response to this question may constitute a thought object, encapsulating a customer's unique perspective and feedback. These thought objects can then be processed using the methods described herein, such as embedding generation, similarity comparison, and diverse selection using LLMs, to identify a subset of responses that represent a wide range of sentiments, experiences, and insights shared by the customers.

Applying thought object analysis to survey responses offers several benefits. It may allow organizations to efficiently process and derive meaningful insights from large volumes of qualitative survey data, which may otherwise be challenging to analyze manually. By selecting a diverse set of representative responses, decision-makers can gain a comprehensive understanding of the range of opinions, issues, and suggestions expressed by the respondents. This information can then be used to inform product improvements, service enhancements, or other strategic decisions based on the voice of the user.

Furthermore, the selected diverse thought objects from survey responses can be used to generate summary reports, testimonials, or user stories that showcase the breadth of feedback received. These curated sets of responses can be shared internally within an organization or externally with stakeholders to provide a balanced and inclusive view of the survey results, highlighting both positive and constructive feedback.

Advantageously, the concept of thought objects extends beyond communication exchanges and can be effectively applied to survey responses. By treating individual survey responses as thought objects, the techniques described herein may be used to analyze, filter, and select a diverse and representative set of responses, enabling organizations to derive valuable insights from qualitative survey data and make informed decisions based on the diverse perspectives shared by the respondents.

During operation, a plurality of thought objects may be received from a plurality of participant devices 620 (referring to FIG. 6A) providing a means for large-scale involvement of users via devices 620 in a networked environment to participate quantitatively to evaluate thought objects that require an understanding of interest regardless of device location, temporal displacement (i.e. when the respondents responded), psychology (willingness to provide qualitative responses in an open forum, or requirement for anonymity), and the like.

On receiving the thought objects, at step 1310, one of the selected non-transformer-based embedding models 655 may be used for generating embeddings for each thought object. The non-transformer models described below may be used for their simplicity, interpretability, and computational efficiency.

Examples of non-transformer-based embedding models 655 may include but are not limited to GloVe, Word2Vec, FastText, and the like.

Further, LDA model generating topic vectors (described in FIG. 12) may be used instead of non-transformer-based embedding models 655.

Embeddings per thought object can be generated using methods such as Latent Dirichlet Allocation (LDA), Latent Semantic Analysis (LSA), or Non-negative Matrix Factorization (NMF). These methods focus on extracting topic distributions and latent semantic structures from the text, providing meaningful vector representations that capture the underlying themes and relationships within the data. These techniques are particularly useful for tasks involving topic modeling and semantic analysis.

Embeddings are generated by embedding models that represent words, sentences, or documents as dense vectors in a high-dimensional space. Embeddings are a fundamental concept in natural language processing (NLP) and machine learning. Embeddings can be used as input features for various downstream NLP tasks, such as text classification, sentiment analysis, named entity recognition, and machine translation. Embeddings are dense vector representations of words, sentences, or documents in a high-dimensional space, capturing semantic and syntactic relationships between them. Embedding may include but is not limited to word embeddings, sentence or document embeddings, and contextualized embedding.

Word embeddings are dense vector representations of words, typically in a high-dimensional space (e.g., 100-500 dimensions). Each word in a vocabulary is mapped to a unique vector in this space. The position of a word's vector in the space is learned based on the word's context and co-occurrence with other words in a large corpus of text. Words that appear in similar contexts or have similar meanings tend to have vectors that are close to each other in the embedding space. Popular word embedding models include GloVe 1301, Word2Vec 1302, and FastText 1303. One of the non-transformer-based embedding models 655 generates word embeddings for each of the received thought objects.

In an embodiment GloVe 1301 (Global Vectors for Word Representation is an unsupervised learning algorithm that generates word embeddings by factorizing a matrix of word co-occurrence statistics. It learns embeddings by minimizing the difference between the dot product of two-word vectors and the logarithm of their co-occurrence probability.

In an embodiment, Word2Vec 1302 is a shallow neural network that learns word embeddings from large text corpora. Trained either using the Continuous Bag of Words (CBOW) or Skip-Gram model, it produces a dense vector for each word, capturing semantic and syntactic meanings. Word2Vec embeddings capture semantic and syntactic relationships between words, such that similar words have similar vector representations.

In an embodiment, Continuous Bag-of-Words (CBOW) 1305 each thought object may be represented as an unordered collection of words without any regard for grammar or word order. Each thought is represented as a vector where each dimension corresponds to a word from the corpus, and the value is often the count of that word in the document Predicts a target word based on its surrounding context words.

In an embodiment, TF-IDF 1306 Enhances the BoW 1305 model by weighting the word frequencies by a measure of how unique they are to the document in comparison to the entire document corpus. It helps in reducing the weight of the words that appear more frequently across all documents and are less informative.

In an embodiment, FastText 1303 is an extension of Word2Vec that learns embeddings for character n-grams instead of just words. It represents each word as a bag of character n-grams, allowing it to capture subword information and handle out-of-vocabulary words better.

In an embodiment, Latent Semantic Analysis (LSA) 1304 is a technique that learns low-dimensional representations of words and documents by applying Singular Value Decomposition (SVD) to a matrix of word-document co-occurrences. It captures latent semantic relationships between words and documents. The use of SVD on the term-document matrix reduces its dimensionality, capturing the underlying structure in the use of words across documents. This process helps in identifying patterns and relationships between terms.

At step 1315, word embeddings generated for each thought object may be combined. Once the word embeddings for the thought objects are computed at step 1310, then the embedding per thought may be calculated using Siamese network 657. Siamese network 657 is a type of neural network architecture that is particularly useful for similarity tasks. When used for combining embedding inputs, word embeddings are identified. Rather than classifying inputs, Siamese networks learn to differentiate between inputs. Siamese network 657 may include solutions including but not limited to Simple Averaging or Weighted Averaging, RNN, LSTM, GRU, attention mechanisms, and pooling.

In simple averaging, the embeddings for a thought object are summed up and then divided by the total number of words. This gives equal importance to all words and creates a single vector representation for the entire text. In weighted averaging equal importance is assigned to all embeddings and weighted averaging assigns different weights to each embedding based on its significance. Common weighting schemes include TF-IDF and Smooth Inverse Frequency (SIF).

In an embodiment, Recurrent Neural Networks (RNNs) are a class of neural networks designed to process sequential data. They can take a sequence of word embeddings as input and generate a fixed-size vector representation of the entire sequence. Basic RNNs have limitations in capturing long-term dependencies due to the vanishing gradient problem. To overcome this, variants like Long Short-Term Memory (LSTM) and Gated Recurrent Units (GRUs) are commonly used. LSTMs and GRUs introduce gating mechanisms that allow them to selectively remember or forget information over long sequences, making them effective for capturing long-range dependencies in text.

In an embodiment, attention mechanisms assign different weights to each word embedding based on its relevance to the task at hand. In an embodiment, pooling operations are used to aggregate information from a sequence of word embeddings into a fixed-size vector representation.

At step 1320, embedding computed for each thought object is stored in object database 611 as a thought object topic table. n an embodiment, embedding metrics like cosine distance or Euclidean distance may be used to quantify the dissimilarity between M thought objects and N thought objects and identify dissimilar thought objects that are likely to cover different topics.

The vector representations (embeddings) generated for each text in thought objects, capture its overall semantic content. Dissimilar texts will have embeddings that are farther apart in the vector space. Once we have an embedding for each thought object, we can measure the similarity between the thought objects using vector operations. Common metrics include: a) Cosine similarity: This measures the angle between two embeddings, with higher values indicating more similar directions (i.e., similar semantic content). b) Euclidean or L2 distance: This measures the straight-line distance between two embeddings in the vector space, with smaller distances indicating more similar texts. c) Dot product: This measures the alignment between two embeddings, with higher values indicating a more similar orientation (but also affected by the embeddings' magnitudes).

FIG. 14 is a flow diagram illustrating a method for determining diverse thought objects, according to an embodiment of the invention. The steps of the method described in FIG. 14 may be performed by LLM 650 to determine diverse thoughts in the received thought objects. In an embodiment, LLM 650 may be a decoder transformer model 640. In another embodiment, LLM 650 may be an encoder-decoder model.

At step 1402, LLM 650 may receive predefined prompts and thought objects via a prompt. The prompt is provided by the thought object selection system 600A with thought objects, and the N thought objects to LLM 650. The prompt includes a request to the LLM to identify a single diverse thought objects. In an embodiment, more diverse thought objects may be requested.

Thought objects may include M thought objects that have been previously and/or recently displayed to participant devices 620 and N thought objects that have been least displayed to participant devices 620. In an embodiment, at least one predefined prompt may include instructions that can guide LLM 650 to perform tasks related to diverse thought object selection. Predefined prompts help in structuring the input and providing clear instructions to LLM. They can be used to specify the desired format, style, tone, or content of the generated text. At step 1404, LLM 650 compares the M objects with the N thought objects.

At step 1406, LLM 650 identifies dissimilar thought objects among the N thought objects with semantically different content. In an embodiment, embedding metrics like cosine distance or Euclidean distance may be used to quantify the dissimilarity between M thought objects and N thought objects and identify dissimilar thought objects that are likely to cover different topics.

The vector representations (embeddings) generated for each text in thought objects, capture its overall semantic content. Dissimilar texts will have embeddings that are farther apart in the vector space. Once we have an embedding for each thought object, we can measure the similarity between the thought objects using vector operations. Common metrics include: a) Cosine similarity: This measures the angle between two embeddings, with higher values indicating more similar directions (i.e., similar semantic content). b) Euclidean or L2 distance: This measures the straight-line distance between two embeddings in the vector space, with smaller distances indicating more similar texts. c) Dot product: This measures the alignment between two embeddings, with higher values indicating a more similar orientation (but also affected by the embeddings' magnitudes).

At step 1408, LLM 650 may select and return one dissimilar N thought objects from the set of N thought objects. In an embodiment, a thought object that among the least displayed ones is selected that is diverse from the recently viewed thought objects

The skilled person will be aware of a range of possible modifications of the various embodiments described above. Accordingly, the present invention is defined by the claims and their equivalents.

What is claimed is:

1. A thought selection system comprising:
a thought selection server, comprising a processor, a memory, and a plurality of programming instructions, the plurality of programming instructions when executed by the processor cause the processor to:
receive a plurality of thought objects, wherein the plurality of thought objects comprises text present in qualitative responses received from a plurality of user devices, wherein the plurality of thought objects comprises M thought objects that are most recently seen thought objects and N thought objects that are least seen by the plurality of user devices;
provide, a prompt, to a Large Language Model (LLM) in communication with the thought selection server, wherein the prompt comprises a request to identify diverse thought objects and the M thought objects and the N thought objects;
compare, the M thought objects and the N thought objects to identify one or more dissimilar thought objects in the N thought objects, wherein comparison is performed based on semantic distances between embeddings associated with the M thought objects and the N thought objects; and
select one or more thought objects from the dissimilar thought objects as a diverse thought objects.

2. The system of claim 1, wherein the semantic distances comprise a cosine distance or Euclidean distance between the embeddings.

3. The system of claim 1, wherein the LLM is a foundation model.

4. The system of claim 1, wherein the qualitative responses comprise one or more text segments present in reviews, survey data, emails, Instant messaging (IM), discussion forums, or any text from communication platforms.

5. A computer-implemented method for selection of thought object, the method comprising:
Receive, at a thought selection server, a plurality of thought objects, wherein the plurality of thought objects comprises text present in qualitative responses received from a plurality of user devices, wherein the plurality of thought objects comprises M thought objects that are most recently seen thought objects and N thought objects that are least seen by the plurality of user devices;
provide, a prompt, to a Large Language Model (LLM) in communication with the thought selection server, wherein the prompt comprises a request to identify diverse thought objects and the M thought objects and the N thought objects;
compare, the M thought objects and the N thought objects to identify one or more dissimilar thought objects in the N thought objects, wherein the comparison is performed based on semantic distances between embeddings associated with the M thought objects and the N thought objects; and
select one or more thought objects from the dissimilar thought objects as diverse thought objects.

6. The computer-implemented method of claim 5, wherein the semantic distances comprise a cosine distance or Euclidean distance between the embeddings.

7. The computer-implemented method of claim 5, wherein the LLM is a foundation model.

8. The computer-implemented method of claim 5, wherein the qualitative responses comprise one or more text segments present in reviews, survey data, emails, Instant messaging (IM), discussion forums, or any text from communication platforms.

9. A thought object selection system comprising:
a thought object selection server, comprising a processor, a memory, and a plurality of programming instructions, the plurality of programming instructions when executed by the processor cause the processor to:
receive a plurality of thought objects, wherein the plurality of thought objects comprises text present in qualitative responses received from a plurality of user devices;
generate word embedding for each thought object using a non-transformer based embedding model; and
combine, the generated word embeddings to generate embedding per thought object.

10. The thought selection system of claim 9, the plurality of programming instructions when executed by the processor cause the processor to:
determine, based on semantic dissimilarity, diverse thoughts present among the plurality of received thought objects, wherein the semantic dissimilarity is identified based on cosine similarity or Euclidean distance.
